(19) United States
(12) Patent Application Publication
(10) Pub. No.: US 2008/0010139 A1
(43) Pub. Date: Jan. 10, 2008

(54) Networked media distribution

(76) Inventors: Stephanie Elmer, Bloomington, MN (US); Nicholas D. Bullinger, Minneapolis, MN (US)

Correspondence Address: FISH & RICHARDSON P.C., PO BOX 1022, MINNEAPOLIS, MN, 55440-1022, US

(21) Appl. No.: 11/472,115

(22) Filed: Jun. 21, 2006

(51) Int. Cl. G06Q 30/00

(52) U.S. Cl. 705/14

(57) ABSTRACT

A computer-implemented method for improving the distribution of electronic media is disclosed. The method includes forming relationships among users of a media administration system, initiating a time-limited campaign for promoting the distribution of one or more related media items, obtaining information regarding on-line media purchases of the one or more related media items by the users of the media distribution system, and allocating points for the media purchases across related users based on the relationships among the users.

### TECHNICAL FIELD

This disclosure discusses to the distribution of music, video, similar electronically-formatted media and other products or services in a networked environment, and more particularly to systems and methods for permitting members of an on-line service to direct their acquaintances to music, other media, or other products or services and to receive awards in return.

### BACKGROUND

The sale of music and video over the Internet is growing rapidly, with users spending millions of dollars on individual songs, on albums, and on televisions shows and movies. This new mode of media distribution, which departs severely from traditional distribution via records, CDs, and DVDs in retail stores, brings a tremendous opportunity to expand the market for digital entertainment content. Specifically, users may purchase more content when they can obtain it easily (e.g., without having to drive to a store), and they may also have extensive choice, receive unique opportunities to locate media (such as by recommendations from other users) and to sample the media before buying it (such as by listening to short samples of a song), they can buy only a single song or an entire album, they can group different songs or programs as they like, and can form “community” with other users who share their interests.

Internet media distribution raises a number of challenges, however. First, piracy. With the ability to make perfect bit-for-bit copies of a song or program, and to distribute copies in a frictionless manner, people can distribute music and other content like they have never been able to before. Content creators have tried legal and technological avenues to stop sharing of content. For example, the record industry has filed a number of lawsuits against users of peer-to-peer networking services that permit for easy sharing of digital files, including music files. On the technological side, content creators and hardware manufacturers have worked to develop ever-more-strict digital rights management (DRM) schemes to prevent copying, or at least mass copying.

Another challenge with internet media distribution is in balancing the roles, and the rewards, of each participant, whether artist, label/studio, or distributor (e.g., iTunes, Best Buy, etc.). With traditional distribution, the roles are fairly well set after years of negotiating contracts with individuals and union members. But with electronic distribution, some of the roles have changed dramatically. For example, many artists are self-publishing, and trying to eliminate the need for a label. Also, distribution is moving from physical retail outlets to on-line media centers like iTunes. All of these changes have left uncertain the proper model for electronic media distribution in the future.

### SUMMARY

This document describes systems and methods for internet distribution of media, such as music, television shows, and movies. Although much of the document discusses electronic media distribution in an exemplary manner, other products and services may also be handled.

In general, an on-line media center is established with which users may sign up to be members. The media center serves as a centerpiece between such members and artists, so that artists (either alone or through a management firm such as a record label) may promote their works and attempt to have additional people buy their works. Members may form relationships with other members, and may cause other members to buy the works, such as by recommending works to other members. The recommending members may then receive points when people who have been associated with them make a purchase. Such members may then use the points to acquire items of value, such as money or particular artist-related merchandise, including autographed materials, concert tickets, and other free works from the artist.

The systems and methods described here may provide one or more of the following benefits or advantages. Artists may be given an improved mechanism by which to reach out to their fans and to build their fan base. Artists may also be able to provide to their fans something that is of very high value to the fans, but of relatively low costs to the artists. For example, artists may provide special content (e.g., exclusive singles, outtakes from programs, or so-called “bootleg” recordings), signed merchandise, or tickets to concerts, parties, and backstage areas. Moreover, artists may develop greater dedication from their fans and camaraderie among their fans, such as by scheduling special events, including private parties and concerts (whether live or on line).

Labels may benefit by spreading news about their various acts more efficiently via viral marketing techniques. Labels may also receive more immediate feedback regarding the success or lack of success of various projects. In addition, labels may obtain more revenue when users are able to communicate more about good content, and to tailor the content they order to their own needs. For their part, distributors will share in any increase in sales. They will also have a larger group of potential customers available to them, as certain members drive sales to other members through them.

Finally, users benefit whether they are driving sales to other users or buying content themselves. Those driving sales, of course, can obtain merchandise and other items of value. Other users may be directed to music or other content that they are likely to enjoy, based on their shared taste with driving members who recommend content to them. In addition, users may be exposed to content they would not normally have found on their own, and may also be given an opportunity to drive sales for other users, and thereby obtain free merchandise and other items of value for themselves.

In areas other than electronic media distribution (e.g., music, television, and movies), the systems and techniques described here may also provide benefits in tracking relationships between and among users of a system, and incenting users to encourage positive actions by other users. For example, charities may use such systems to encourage donating parties to recruit and encourage other parties to donate. Also, consumer products companies may use relationships between and among their customers and potential customers to spread the word about new products, and to improve the distribution of such products to users who might find the products most helpful. Providers of services (e.g., telephone or television service, etc.) may use such systems in a similar manner. For example, users of service may receive free or discounted services for referring others to a system or for increasing the usage of a system by others.

In one aspect, a computer-implemented method for improving the distribution of electronic media is disclosed. The method comprises forming relationships among users of a media administration system, initiating a time-limited campaign for promoting the distribution of one or more related media items, obtaining information regarding on-line media purchases of the one or more related media items by the users of the media distribution system, and allocating points for the media purchases across related users based on the relationships among the users. The information regarding on-line media purchases may be obtained from one or more organizations that are independent of the media administration system.

In some implementations, the points may be allocated across multiple distances of relationship, with fewer points awarded for more distant relationships. Also, the relationships among the users may include referral relationships formed for a single media item. The campaign may also be time-limited according to a time to award a predetermined number of points, and the method may further comprise directing the award to be delivered to users of items of value related to the media items.

In yet other implementations, the direction may be given to an entity associated with an artist that created the one or more media items. Also, the media items may comprise individual songs, and the allocated points may be a predetermined number of points that are allocated by computing shares of the total points to be allocated to each of one or more members. The points may also be in the form of a numeric amount convertible to items of value.

In another aspect, a system for managing electronic media distribution is disclosed. The system comprises a member database storing identifiers for members of the system and relationships between members, an interface in communication with one or more media sellers to receive information about media sales by the one or more media sellers along with information identifying one or more members of the system that purchase media, and a point allocation engine adapted to assign points to members in the member database according to relations between the members. The point allocation engine may assign points according to a method selected by a content vendor.

In some implementations, the system may also include a campaign manager module that controls the award of points to members during a defined campaign time period. Also, the point allocation engine may assign points across multiple distances of relationship, with fewer points awarded for more distant relationships, and the relationships among the users may include referral relationships formed for a single media item.

In yet other implementations, the system may further comprise an interface in communication with award fulfillment entities that directs the award fulfillment entities to deliver merchandise to members in exchange for accrued member points. The system may also include a media library and a fulfillment module for delivering media in the library to members in exchange for accrued member points.

In yet another aspect, a computer-implemented method is disclosed that comprises identifying relationships between a plurality of users of a networked computer award distribution system, defining one or more point allocation structures for controlling points to be awarded to first users as a result of purchase transactions by second users based on relationships between the first and second users, obtaining information regarding purchases of one or more items by the second users, and allocating points for the purchases across related users based on the relationships among the users. The information regarding purchases may be obtained from one or more organizations that are independent of the media administration system, and the points may be allocated across multiple distances of relationship, with fewer points awarded for more distant relationships. In addition, the method may also include obtaining the information regarding purchases during a campaign that is time-limited according to a time to award a predetermined number of points.

In another aspect, a system for managing electronic media distribution is disclosed, and includes a member database storing identifiers for members of the system and relationships between members, an interface in communication with one or more media sellers to receive information about media sales by the one or more media sellers along with information identifying one or more members of the system the purchase media, and means for allocating points across members of the system in relation to transactions by members with the one or more media sellers.

The details of one or more embodiments are set forth in the accompanying drawings and the description below. Other features, objects, and advantages will be apparent from the description and drawings, and from the claims.

### DESCRIPTION OF DRAWINGS

FIG. 1 is a schematic diagram showing a system for distributing media items over a network.

FIG. 2 is a schematic diagram of components in a network-based media distribution administrator.

FIG. 3 is a flow diagram showing actions taken by entities related to a media distribution administrator.

FIG. 4 is a diagram that shows the accrual of points to members of a media distribution system.

FIG. 5 shows a number of exemplary use cases for a media distribution system.

FIG. 6 is a flowchart showing actions taken by a member of a media distribution system in joining a campaign.

FIG. 7 is a flowchart showing a purchase of merchandise by a member.

FIG. 8 is a flowchart showing the assignment of points to members of a media distribution system.

FIG. 9 is a flowchart showing the redemption of points by a member.

FIG. 10 is a flowchart showing actions taken by a vendor in establishing an account with a media distribution system.

FIG. 11 is a flowchart showing actions taken by a vendor in creating a campaign.

FIG. 12 is a flowchart showing the redirection of a user to a media distributor.

FIG. 13 is a flowchart showing confirmation of a transaction with a media distributor.

FIG. 14 is a flowchart showing actions for establishing a new vendor with a system.

FIG. 15 is a flowchart showing the creation of a campaign by an administrator.

FIG. 16 is a flowchart showing actions for launching a campaign.

FIG. 17 is a flowchart showing actions for managing a campaign.

FIG. 18 is a flowchart showing actions for sending items of value as a reward to system members.

FIG. 19 is a flowchart showing the ending of a campaign and the provision of points to members.

FIG. 20 is a flowchart showing the creation and maintenance of a home page for an artist.

FIGS. 21A-21C show exemplary web site maps for a music distribution system.

FIGS. 22A-22B show a flowchart of a process for purchasing a song using a music distribution system.

FIG. 23 shows graphically a mechanism for allocating points.

FIG. 24 is a schematic diagram showing components in a computer system suitable to be used with the systems and methods described in this document.

Like reference symbols in the various drawings indicate like elements.

### DETAILED DESCRIPTION

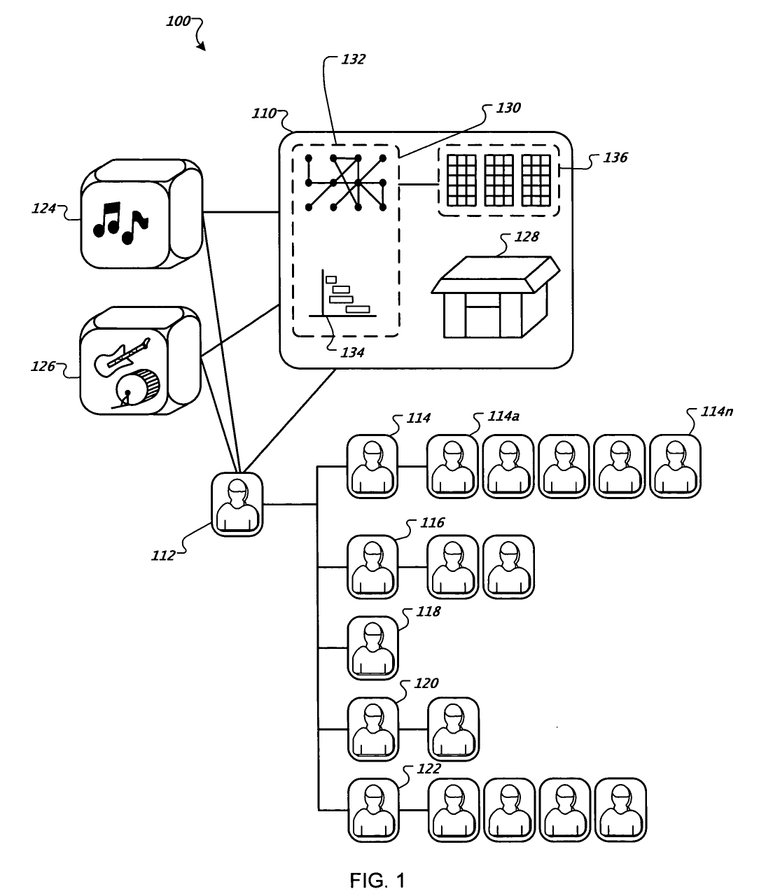

FIG. 1 is a schematic diagram showing a system 100 for distributing media items over a network. In general, an administrator 110 coordinates the interaction of various other entities in the system 100. For example, the system centers around a number of members 112-122, who may use the system 100 to acquire electronic media, such as digital music and movie files. Other goods or services, including physical goods may also be acquired. The members 112-122 may be incented toward buying certain content both by other users, such as user 112, and by a vendor 126, which may be an artist or agent of an artist, such as a record label. Where one member incents other members to buy content, such as by establishing a defined relationship with them or by otherwise serving as a referrer to them, that member may be awarded points that they may redeem for special offers or other items. The administrator may also be the seller of the content, or may cooperate with one or more affiliates 124, such as on-line music stores that sell files in MP3, AAC, WMV, and other formats.

In this manner, the system 100 can provide members 112-122 with reliable information about content that is available. It may also provide them with simple and familiar mechanisms (e.g., their favorite on-line media store) by which to acquire the content. In addition, the system 100 encourages members 112-122 to become leaders and to get other members to purchase music through them. Those leaders can accumulate points or other items of value, thereby encouraging them to work harder to be seen by others as a leader.

Administrator 110 in the pictured embodiment generally serves as manager of the relationships of members 112-122 with the system 100. The administrator 110 may be part of an organization that serves as a intermediary between members 112-122, vendors 126, and affiliates 124. The administrator 110 may operate a web site using one or more web servers and associated computers which members 112-122 and vendors 126 may access to manage their accounts with the system 100.

A member database 136 in the administrator 110 stores identifying information for members 112-122 along with information defining relationships between and among the members 112-122. For example, each member, such as member 112, may be assigned an identification number. Other information specific to the member 112 may also be tracked. As one example, media purchases made by the member may be tracked so that the member may accrue points or other items in relation to the number of items purchased or the cost of those items.

In addition, the database 136 may track relationships between member 112 and other members 114-122, which may be termed acquaintances of member 112. The relationships may be formed in various manners. For example, a member may invite other people to join system 100, and when those people join, that are given a relationship to the member who recruited them. To do so, a member, such as member 114, may interact with system 100 to have e-mails or other messages sent to people the member 114 knows. The message may include a link back to system 110 that the recipients may select to be given an opportunity to become a member of system 100.

The relationships may be organized hierarchically so that member 112 is in a position dominant to the other members 114-122. Multiple dimensions of relationships may also be formed, so that a member who is dominant in one context may not be dominant in another. For clarity, the figure shows one dimension of relationships, with member 112 and all of the acquaintances of member 112 who report to member 112.

Member 114 may be one member over whom member 112 is dominant. In turn, member 114 may dominate over members 114a to 114n, and by extension, member 112 may dominate over all of those additional members. Similar relationships are shown for members 116, 120, and 112. Member 118 is not dominant over any other members, at least for the pictured dimension of relationships. That may be because member 118 has just joined system 100 and has not had time to attract any other member. Or it may be because member 118 is content simply to receive information from other members, and to make purchases based on that information.

Member 112 may also have a dominant relationship by virtue of recommendations made to other members. For example, member 112 may cultivate an expertise in a particular genre of content, such as horror movies. Member 112 may track developments in that genre, such as by writing a blog or providing other forms of review of songs or programs. Other members may come to understand that they share similar tastes with member 112 and that member 112 is often accurate when reviewing songs or programs. Those members may then institute purchases from a web page managed by member 112, for which member 112 may be considered dominant for the relevant transaction or transactions.

The relationships between and among members may be managed by relationship module 132. Module 132 may take data from member database 136 and form and track relationships. Such relationships can be permanent or semi-permanent, such as those assigned when users become members at the behest of another member. The relationships may also involve multiple degrees of separation, and relationship module 132 may derive the number of degrees of separation between two members. In addition, as described in more detail below, relationship module 132 may also compute points for various members if one member makes a purchase of a media item.

For example, points may be allocated by the tightness of a relationship. So, for an example using arbitrary numbers, points may be awarded on a fast-declining basis so that a dominant member may receive four points (or four points multiplied by a dollar value of sales) for purchases by a direct relation, two points for purchases by a direct relation of the direct relation, one point for a purchase by a member one additional step removed, and one-half point for a purchase by a member one additional step removed from that. A total point level may also be assigned, so that each member in a chain of relationships may obtain a computed percentage of the total points. Thus, where the chain of dominance has fewer members, those members in the chain will receive more points because there are fewer members with which to share the points.

Relationship module 132, along with campaign manager 134, makes up a media manager 130. The role of media manager 130 in the pictured embodiment is to present information about available media to members, and to assign and allocate points or other items to members based on their relationships to the various purchasers.

Campaign manager 134 carries out instructions for promoting certain content such as newly issued content. Campaigns are generally events that occur over a defined time period during which content may be purchased, and the purchases tracked to reward the buyers or those associated with the buyers so as to encourage additional purchases. Campaign manager 134 may include a scheduler that controls the start and end of the campaign. The scheduler may be set to expire at a certain calendar or clock time, or may be set to another measure of time, such as the time to complete a set number of purchase transactions for a particular media item, or the time for a set number of points to accumulate in user accounts for a promotion. The scheduler may also permit for variable time frames, such as by extending a campaign if a certain sales goal is met or if extension appears to be a profitable route for a campaign.

Campaigns may, in the ordinary course, be instituted by vendors 126. For example, a record label or band may want to promote a new album release with members of system 100. They may, therefore, determine the terms of a campaign, possibly in combination with administrator 110. For example, they may specify the media item or items to be sold as part of the campaign, and may provide identifying information so that those items may be readily obtained from music sellers, e.g., by the administrator directing its members to particular affiliates who are music sellers. The vendors 126 may also specify one or more prizes that may be awarded as part of a campaign. For example, a rock band may award an autographed guitar pick to every member who accumulates a set level of points based on their own purchases of campaign-based media and the purchases by members over whom they dominate. Additional items may be awarded to the top point-getter or the top point-getter during a particular phase of the campaign.

Campaigns may also be sponsored by other entities. For example, the administrator 110 itself may organize and carry out campaigns, such as to promote the system 100 to users. As one example, users may be given points when they first become members. Also, entities such as music stores or record labels may compensate administrator 110 for carrying out a campaign directed to specific media or groups of media (e.g., a show or block of shows carried by a television network).

On-line store 128 may also be provided by administrator 110 to offer items to members 112-122. The items may be purchased by money, by points, or by a combination of the two. For example, members 112-122 may accumulate points during a campaign in parallel with points they accumulate relative to winning items offered by the vendor offering the campaign. To the extent their points are not exhausted obtaining items being offered as prizes in a campaign, the members 112-122 can apply the points to items in the store 128.

The store 128 may offer a variety of items to members, and may also offer items to non-members (e.g., for a higher price than for members). For example, the store 128 may offer clothing such as t-shirts relating to particular artists. In addition, music may be offered, such as in the form of downloadable files. Such an offer may also occur by redirecting users to a third-party carrier of music files so that administrator 110 need not build the infrastructure for such an operation. When such redirection occurs, administrator 110 may share messages with such a site, such as an affiliate 124, so that the affiliate 124 is compensated for providing the download. In addition, the store 128 may offer subscriptions to members 112-122, such as subscriptions to a streaming music service or limited-term music download service. In such a situation, members 112-122 may be incented to continue acquiring points so as to maintain their subscriptions.

While administrator 110 may deliver on-line content itself, it may alternatively or additionally associate with affiliates 124 to provide such content, and may also work with affiliates 124 to deliver other items. In this manner, administrator 110 can avoid having to manage stocking, inventory, and shipping of items, or delivery of electronic content. For example, as described in more detail below, administrator 110 may direct a user to an affiliate 124, such as the Apple iTunes Store, in a manner that the affiliate 124 can understand that the user is a member of the system 100. The affiliate 124 may then take orders from the member and see to it that files or items are delivered as appropriate. The affiliate 124 may then charge the member directly, for example, if the member has an account with the affiliate 124. Alternatively, the affiliate 124 may charge the administrator 110, which may in turn charge the member.

In operation, a member 112 may enroll with system 110, and may invite a number of acquaintances to join also, such as by providing their e-mail addresses to the administrator. Those acquaintances may then join as members 114-122, and may be associated with member 112. The member 112 may learn of a new set of songs released by a particular artist, and may audition the songs, either through administrator 110 or through affiliate 124. If the member 112 likes the songs, he or she may send a message through administrator 110, or separately via e-mail, to members 114-122, telling them about the music and encouraging them to purchase it. The message may contain structures for easily directing the other members 114-122 to the music, such as hyperlinks or other appropriate structures. Those structures may identify the member 112, so that subsequent action by members 114-122, such as purchases, may be attributed to member 112.

Where members 114-122 subsequently purchase any of the songs, member 112 may be rewarded points, such as general points that can be redeemed independently of a particular campaign, or specific points which may be redeemed against campaign-specific items. For example, if member 112 drives more than ten sales, he or she may be provided one of the songs for free. In this situation, the member 112 is rewarded for making a referral.

Another member may also be awarded points, such as a member who originally referred one of members 114-122 to system 100. Members that are one or more layers removed may also receive points. The points may be allocated according to a formula specific to the promotion, to an algorithm, or to any other appropriate formula. In one example, the points assigned to a member for attracting other members to system 110 may decrease over time so that the dominating member receives the most points for encouraging new members to be active in system 110.

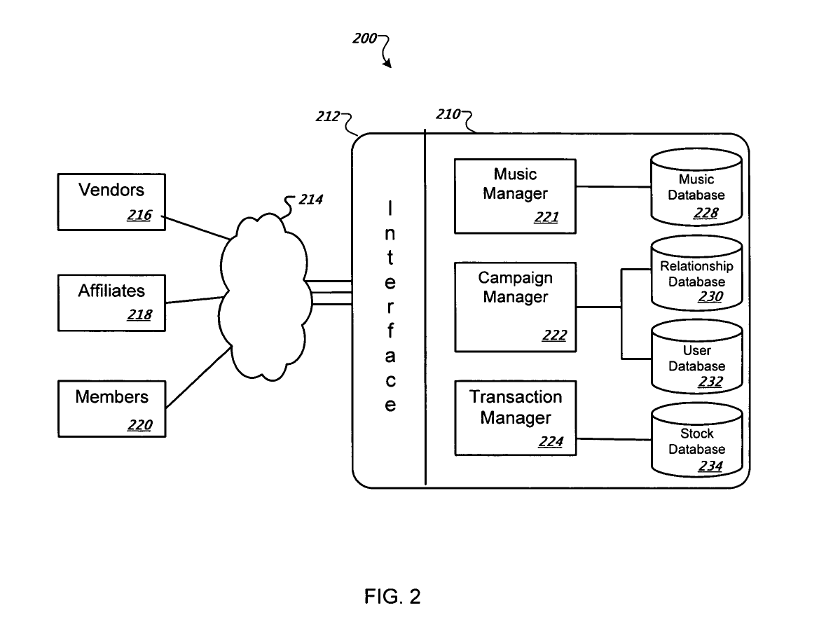

FIG. 2 is a schematic diagram of components in a network-based media distribution administrator 200. Such an administrator 200 may be employed, for example, in the system 100 shown in FIG. 1. The administrator generally communicates with other entities through a network 214, which may comprise a LAN, WAN, the internet, and/or other networks or network components. The administrator communicates, for example, with vendors 216 (e.g., artists, labels, and networks), affiliates 218 (e.g., on-line content stores), and members 220 (e.g., users who have registered with administrator 110). The general roles played by each of these entities may be similar to those played by the corresponding entities discussed with respect to FIG. 1.

Administrator 200 may communicate with network 214 via interface 212, which may include one or more web servers or other similar devices. Other components of administrator 200 may also be part of the web servers or may supplement the web servers as appropriate. The particular number and arrangement of servers is not critical, and various appropriate arrangements may be used.

Various managers within the administrator 200 carry out the appropriate actions for serving members 220 and vendors 216, through, for example, transactions with affiliates 218. As mentioned above, the affiliates 218 may also include services or entities that are part of or in the same organization with the administrator 200.

Music manager 221 may be provided in administrator 200 when administrator 200 provides electronic files to members 220. Music manager 221 may display available music (or other content) to members 220 and receive requests from members 220. Music manager 221 may communicate with music database 228, which can store electronic files that may be acquired by members 220. Music database 228 may store the files in a manner in which digital rights management (DRM) controls may be exercised over distributed copies of content. In that manner, the copying of distributed media may be limited. In addition, music manager 221 may provide content as a streaming signal so as to minimize opportunities to make improper copies of the distributed files.

Music database 228 may contain a full selection of files available to members 220, and thus serve as an alternative to affiliates 228. Alternatively, music database 228 may contain a limited number of files. For example, music database 228 may store files that users may acquire with points earned as part of campaigns or that users may otherwise acquire based on their interaction with the administrator 200.

Campaign manager 222 may permit vendors 216 to establish campaigns to promote certain content, such as by accepting identifying information from vendors 216, and then communicating information about available content to members 220. For example, campaign manager 222 may author e-mails or other messages to be sent to members 220 to notify them of campaigns that have been instituted by vendors 216 in a most-recent predefined time period—such as by sending a new message at the same time each week.

The campaign manager 222 may also separate campaigns according to genre or media type. For example, members 220 may identify types of music they like, such as heavy metal, jazz, R&B, hip hop, and country. When vendors 216 seek to institute a campaign, they may identify their content according to genre, or the administrator may make such a classification, and the content may be communicated only to members who have identified themselves with the genre. In a like manner, content may be classified according to its format, such as single songs, groups of songs (albums), television programs, short films, and feature films, among others.

The campaign manager 222 may draw on relationship database 230 and user database 232, among others, for its information. User database 232 may store general information about each of the members 220 of the system. For example, user database 232 may maintain information such as a unique identifier for each member, contact information for each member, payment information (e.g. credit card number) for a member, genre and other preferences for each user, and points accrued to each user.

Relationship database 230 maintains connections between and among members 220, such as by defining relationships between a pair of members. Such relationships may be direct and long-term, such as when one member induces another person to joint the system as a member. A relationship may also be short-term, such as when one member serves as a referral to another on a particular item of digital content. The relationship may also be indirect, such as when a member induces another person to become a member, and that second member then induces a third person to become a member. The relationship database may be queried as necessary, such as to obtain an indicator of the degree of relationship between two members when allocating points for one member's purchases to other members.

Transaction manager 224 may manage the assignment and distribution of prizes or other items of value to members 220. For example, in the course of a campaign or when a campaign is completed, campaign manager 222 may assign points to various members 220 and may update the user database accordingly. Campaign manager 222 may then cause certain items to be provided automatically to certain members 220, such as members 220 who meet a predefined goal for a campaign. In doing so, campaign manager 222 may communicate with transaction manager 224, indicating the item or items to be provided and the relevant identifying information for the member.

Alternatively, members 220 may institute a transaction, such as by visiting an on-line store and using accrued points to obtain an item. The transaction manager 224 may check user database 232 in such a situation to verify the identity of the member and to determine whether the member has sufficient points or other funds to obtain the requested item or items.

Transaction manager 224 may then carry out the necessary steps to have items provided to members 220. Where the items are electronic items, transaction manager may communicate with music manager 221 or affiliates 218 to have the items downloaded to the member's device. Where the items are physical items, the transaction manager 224 may cause the items to be shipped to a member. Transaction manager 224 may draw on stock database 234 in doing so, to ensure that the items are still in stock. If an item is out of stock or low on stock, transaction manager 224 may cause additional such items to be obtained. The physical inventory may be stored by the organization that operates administrator 200, or by another organization. In the latter situation, the administrator's organization may avoid taking on the expense of handling physical inventory.

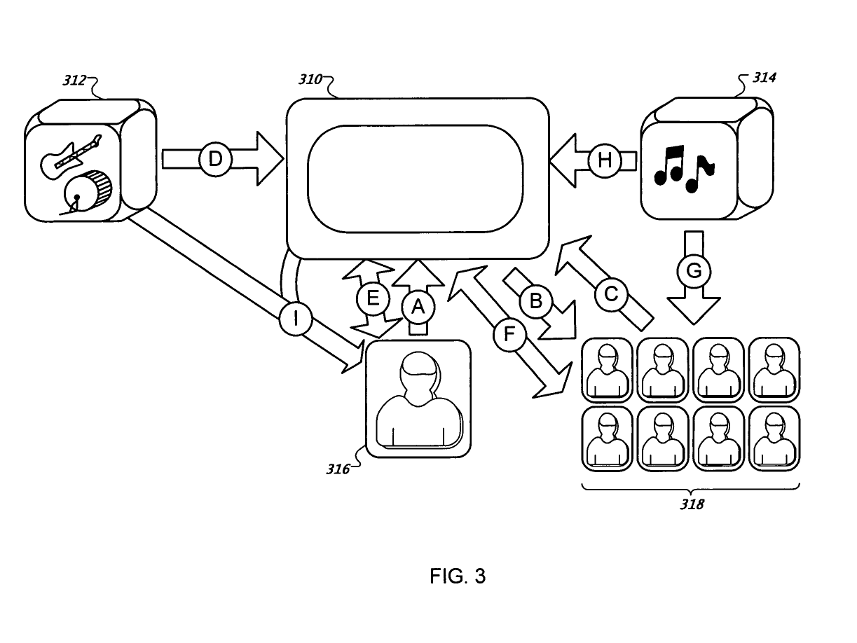

FIG. 3 is a flow diagram showing actions taken by entities related to a media distribution administrator 310. In general, actions and communications between entities in the system occur according to labeled arrows, which generally occur in order starting at A. However, as appropriate, various steps may occur in a different order, steps may be added, or steps may be removed and/or replaced with other steps.

In an initial step, a member 316 registers with administrator 310. This action may involve the member visiting an internet web site operated by the administrator 310 and filling out an on-line form that provides identification and other information. Alternatively, member 316 may receive a message such as an e-mail whose transmission has been initiated by someone who knows member 316 and is already a member of the system. The registration of member 316 is indicated by Arrow A.

After member 316 has joined, he or she may cause invitations to be sent to their acquaintances, such as via e-mail message (Arrow B). Those people may ignore the invitation, decline it, or accept it. Arrow C shows responses (whether declining or accepting) by those acquaintances, to the system. Where any of the other users 318 accept, they may be prompted for identifying and other information, and may then be made members. They may then invite other people to join as members.

At an earlier or later time, a vendor 312 may communicate with administrator 310 to establish and define a campaign, as shown by Arrow D. The vendor 312 may initially register with the system. The vendor 312 may then include a sample of the content to which the campaign is directed, so that members can get a feel for the content before spending money. In addition, the vendor may identify items to be distributed as rewards for members who purchase a certain amount of content or have sufficient relationships with respect to other members who purchase the content. The vendor 312 may also define the number of points available for distribution for each purchase, and may also outline how points are to be allocated (e.g., more points to referring members than to those who initially brought other members to the system). The vendor 312 may also identify the number of rewards available, and the triggers for obtaining such awards. For example, a vendor 312 may have a relatively unlimited supply of some rewards (e.g., autographed merchandise) and so may award it at certain defined point levels in a campaign. Other items may have a much more constrained supply (e.g., backstage passes), so that a set number are awarded, for example, to the five members with the highest point totals for a campaign. Various other point value arrangements may be established to incent members toward certain actions, such as bonus points for sales of full albums of songs, and additional points for activity early in a campaign so as to kick off a campaign strongly.

At Arrow E, member 316 learns of the campaign established by vendor 312, and interacts with the administrator 310 to obtain more information about the campaign. Member 316 determines that the content, e.g., songs, from vendor 312 is something that member 316 really likes, so that member 316 writes a very favorable review of vendor 312. The review may be posted on a web site run by member 316, along with information connecting it back to administrator 310 so that visitors to the site will be directed to administrator 310 or affiliates 314 of administrator 310 if they choose to buy the content. Member 316 may also format the review in another form, such as in a weekly e-mail to other users that contains reviews.

At Arrow F, the other members 318 may interact with the review created by member 316. These other members 318 may be at level at which they do not receive initial notice of new campaigns, or they may simply not have the time to follow the introduction of new content so that notice from member 316 is new news to them. If they like the review and believe from it (and perhaps by listening to the sample, such as by clicking a link in the review) that they will enjoy the content, they may begin a purchase transaction.

Alternatively, members 318 may locate the content on their own, whether as part of a campaign instituted by a vendor 312 or simply while browsing for content. In such a situation, member 316 may still be awarded points for the purchases by members 318, for example, if member 316 originally induced the members 318 to joint the system 300.

Arrow G shows the processing of a purchase transaction with one or more of members 318. For example, members 318 may select a link in a communication they receive from member 316, which may redirect their web browser or other appropriate application to a location on a web site of affiliate 314 at which the particular content may be purchased. In the communication, affiliate 314 may be passed a unique identifier that marks the message as originating from administrator 310 along with a MerchandiseID, and an emailed. Affiliate 314 may then pass back the emailed identifier along with a purchase price, and a commission. In this manner, the various components and systems within the greater overall system may coordinate information to permit tracking and posting of orders in each system.

When members 318 confirm their purchases, affiliate 314 may cause the content to be downloaded to the client computers of the members 318. If members 318 have accounts with affiliate 314, affiliate 314 may debit the accounts an appropriate amount for any purchases. Alternatively, affiliate 314 may obtain payment from a third-party payment site, such as a micro payment system. Also, affiliate 314 may communicate with administrator 310 to obtain a credit from administrator 310, and administrator 310 may bill members 318.

When the sale is completed, affiliate 314 may send a communication (Arrow H) to administrator 310 providing necessary identifying information from the transaction. For example, affiliate 314 may include information about the identity of the content purchased, the identity of the purchaser, and the amount spent on the content. Upon receiving the information, administrator 310 may, for example, convert the identifying information into a form usable by administrator 310 (e.g., through a look-up table), and may then “post” the transaction to its system. Specifically, as described in more detail below, the administrator 310 may determine the number of points to be awarded for the sale or sales, and may then allocate the points across the members having a relationship to the purchaser.

Administrator 310 may also obtain a discount with, or a rebate from, affiliate 314 due to a large volume of sales. The administrator may advantageously use that discount or rebate to fund its operations, so that members 318 pay only the nominal amount for content from affiliate 314. Administrator may also include advertising other than member-generated content recommendations, and may derive revenue from such advertising. An advertising engine (not shown) may analyze the text on a web page or content review, and may also identify the actual content such as by comparing the title of an item to a database of items. Upon determining the class of the content, administrator 310 may obtain targeted, relevant promotional material, and may display it along with the information about the particular content. As one example, the promotional material may be in a form of a “If you like [content], then you might like [similar content]” advertisement. In addition, affiliate 314 may also send marketing messages and amounts for marketing for cross sales and up sales, which may be given uniqueID numbers.

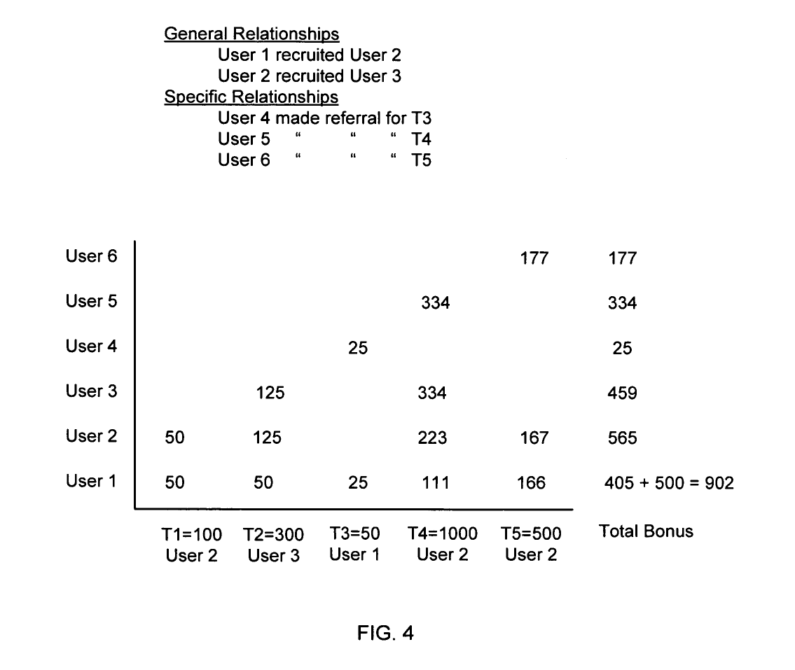

FIG. 4 is a diagram that shows the accrual of points to members of a media distribution system. In general, the diagram shows five discrete purchases of content as part of a campaign or a group of related campaigns-designated as transactions T1 through T5 along the horizontal axis. Six different members or users registered with the system are shown along the vertical axis. The number of points awarded to each member is shown in the body of the chart.

Relationship tables associated with the system indicate that User2 joined the system as the result of an invitation form User1, and User3 joined the system as the result of an invitation from User2. Thus, the first three users are related directly (User1/User2 and User2/User3) or indirectly (User1/User3). These relationships may be termed general relationships because they are not dependent on a particular transaction; rather, a dominant user receives “credit” for actions of another user whenever the other user acts. (The level of credit can vary, of course, depending on the circumstance of the transaction and the distance in time since the first user recruited the second user.)

Several specific relationships are also defined. These relationships may not apply across all sorts of transactions, and may instead be directed to particular transactions or groups of transactions. In the example, the specific relationships are referral relationships. Thus, for example, if User4 makes a recommendation to User3, and User3 follows up by purchasing content or performing other actions of value to the system, User4 may receive some or all of the credit for User3's actions. In the example, User4 has made a referral that ended in transaction 3, User 5 has made a recommendation for transaction 4, and User 6 has made a recommendation for transaction 5.

Following each transaction individually, User2 initially makes a content purchase that translates into 100 awardable points. Here, User2 gets some points for the purchase, and the one other user with a relationship to User2 (i.e., User1) also gets some points. In the example, the sharing of points is equal. Alternatively, User2 may simply be given points separately from any shared points, and the other users having relationships to User2 may split the point pool. Also, point levels may be selected for each user independently, without first establishing a point pool.

At transaction 2, User3 makes a content purchase that translates into 300 awardable points. Here, the reward is split so that direct contacts (User2 and User 3) equally share ⅚ths of the points, and the relation once-removed (User1) receives the final ⅙th.

Lower points for the more distant relationship is logical for multiple reasons. First, as more distant relationships are included, more members become potentially eligible for points. If the awarded point value were not reduced for distant relations, the points would quickly run out, or points for close relationships would need to be unduly reduced. Such an action would dissuade members from establishing direct relationships, and the operation of the system would likely slow. Also, by allocating points in this manner, a campaign can be run in a manner that is profitable, and thus sustainable to the users of the system.

In transaction 3, User1 makes a small purchase, such as for a single song, a short film, or a single-use streaming file. Although User1 was the first to join the system in this example, and thus has no general relationships that would take some of the points, the purchase was made in response to a referral made by User4. As a result, the total points are split evenly.

In transaction 4, User3 makes a purchase worth 1000 total points. User3 gets a large number of points, as does User5 who made the recommendation to User3. User2 and User1 also receive points for their general relationships, direct and indirect, respectively, with User3.

In transaction 5, User2 purchases items that generate 500 points. Here, there are two direct dominating relationships—the general relationship form User1's recruiting of User2, and the specific relationship formed by User2 buying in response to a referral from User6. According to predefined point allocation rules, each of the three users involved receive one-third of the point total, with rounding differences being allocated randomly or according to a rule.

Final point totals are shown at the right edge of FIG. 4 for each user for the campaign. If certain items specific to the campaign may be acquired for 500 points or more, User1 and User2 may acquire such items. Also, note that User1 achieves a predefined goal for the campaign, such as being involved in five transactions or more, and has been awarded 500 bonus points as a result. Alternatively, User1 could simply be awarded an item of value other than points.

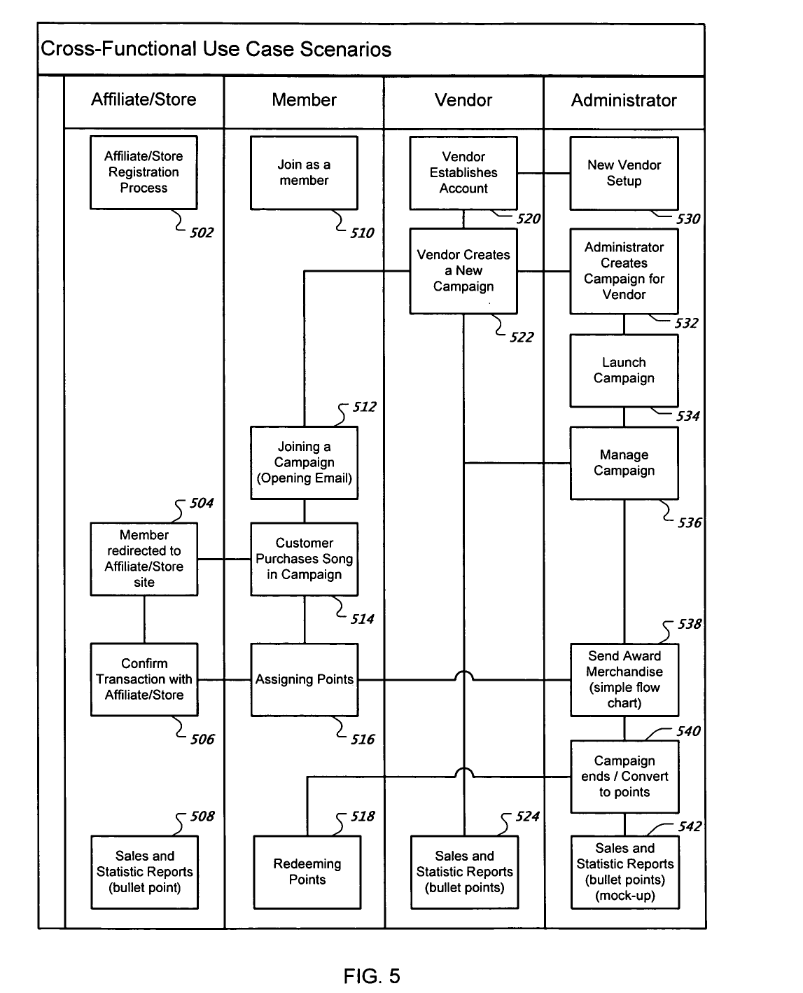

FIG. 5 shows a number of exemplary use cases for a media distribution system. In general, the use cases describe potential actions taken by various entities that interface with an on-line content storefront, such as the administrators discussed above. The use cases relate to, among other things, the registration of various entities with the system, the posting of campaigns, and the ordering by, and rewarding of, members of the system.

The media distribution system includes use cases of affiliates/stores, members, vendors, and administrators. The use cases of the affiliates and stores are similar and are shown together. The affiliate/store use cases relate to actions taken by entities that provide for the control and transfer of content or other products or services to members of the system. For example, the affiliate/store may be an existing, standalone on-line music store, which may interact with users directly or indirectly. For direct interaction, an administrator may redirect a member to the on-line music store, or may instead send commands to the on-line music store to make it deliver content to a particular user, including in a manner that is transparent to the member.

The order of execution of the use cases generally starts with the use cases shown at the top of FIG. 5 and proceeds with the use cases shown lower in the figure as time passes. Use cases that are shown at the same level generally indicate that the use cases may be performed concurrently (e.g. vendor establishes account 520 and new vendor setup 530). Use cases that appear above other use cases are generally performed before those use cases (e.g., member redirected to affiliate/store 504 is performed before confirm transaction with affiliate/store 506). Some of the use cases are not linked directly with other use cases. For example, the affiliate/store registration process use case 502, the join as a member use case 510, and the sales and statistic reports 508 are stand-alone use cases. Other use cases are linked together, indicating that they represent a portion of a larger scenario. The connections between and among use cases may change, however, and the order for execution of use cases may also change, so that the pictured arrangements are meant to be exemplary only.

The top use case for the affiliate/store is a registration process 502 use case, by which an affiliate may submit its desire to form a relationship with an administrator and may submit other information to permit any needed communication between the entities. Of course, where the affiliate and the administrator are large and/or are forming a long-term relationship, such a self-service sign up would generally not be used.

The final use case for the affiliate/store involves obtaining sales and statistical reports relating to transactions occurring through a particular affiliate/store (508). Such reports may help an administrator or an affiliate/store to better track the progress of transactions and the effectiveness of various rules for directing members in particular directions, such as to particular affiliates/stores. Other examples of reports that may be generated include total sales from a campaign, conversion rates (e.g., how many notified users actually buy something) of the campaign, campaign depth (e.g., how many levels of relationships were formed in the campaign), identities and/or statistics for new members signed up through a campaign, sales breakdowns such as by type of merchandise, distribution of awards based on participation, similar reports for vendors across all campaigns, and reports across all stores operated by an administrator. Also, the reporting information may be organized in a convenient manner for ready sharing between administrator and affiliate/store. XML formatting of messages is one such ready option.

The other two use cases for affiliate/store are joined to use cases for other entities and will be discussed with respect to the use cases for those other entities.

As with the affiliate/store, the first use case for the member is the join as a member use case 510. Again, the steps associated with that use case involve a member indicating an intent to join the system, and then providing identifying information such as a credit card number. The first use case for the vendor is also a registration use case (520), which may be a more involved process than the other registration use cases, because vendors may need to submit more information in order to establish a full account. For example, vendors may need to provide copies of content to be distributed or samples of such content, information about how points should be distributed, and other such information. Alternatively, some of a vendor's information could be provided at the time of starting a particular campaign.

At the same time a vendor registers or at a later time, the vendor may also create a campaign, as shown by use case 522. The vendor may identify an initial group of people to be part of the campaign, such as by transferring an e-mail list containing e-mails from a vendor/artists' fan list. In addition, the vendor may provide an audio clip to be played for potential customers, and directions for reaching affiliates (e.g., a URL) who may carry copies of a song or other content. The vendor may also identify any prizes to be awarded as part of the promotion, and define the structure for awarding points for activity under the campaign. The vendor may also allow the administrator to select a point allocation method, such as by a manually predefined approach or other approach.

In addition, the administrator may present the vendor with multiple point allocation profiles, and optionally describe advantages and disadvantages of each such profile, and the vendor may select one such profile. For example, some profiles may award extra points for recommendations for vendors who want to encourage “power users” of the system to look at the vendor's content and recommend it to others. Such a profile may be particularly well-suited to new artists that need effective word of mouth advertising. Alternatively, other profiles may award members who recruit other members by allocating more points for such general relationships. Vendors can be encouraged to select such a profile, which may decrease immediate sales but may encourage members to build an administrator's membership, by being compensated more highly in their transactions involving the administrator. In short, such compensation may overcome the vendor's interest in short-term gain in a manner that helps the long-term health of the administrator.

The creation of a new campaign (522) triggers use cases for the other entities in the system. For example, the administrator will create the campaign (532), which may involve establishing preliminary campaign information, identifying members associated with the campaign and other members having relationships with those members, establishing the terms of the campaign including its timing and the point allocation scheme for the campaign, and verifying the existence of any prizes associated with the campaign.

The existence of prizes may be verified in multiple ways. In one example, a vendor may enter into a binding agreement by which it contracts to deliver prizes according to the terms of the campaign. In addition, a vendor may deliver prizes to a trusted third-party for ultimate delivery by that third-party—effectively escrowing the goods. The vendor may also provide the items to the administrator, particularly where the prizes are electronic files such as exclusive copies of songs or other content. The administrator may also provide certificates for merchandise from other vendors (e.g., providing a gift certificate to an electronic retailer).

As part of creating the campaign, the administrator may also check for the availability of the relevant content at the potential affiliate/stores. For example, the administrator may simply analyze the identifying information provided by the vendor, and conduct a search at each of its potential affiliate/store sites. If the content does not show up as available, the administrator may remove that particular affiliate/store as a potential source of supply for vendors. In addition, the administrator or the vendor may determine that a particular affiliate/store should have an exclusive supply arrangement. In such a situation, the administrator need not check availability of the content from every possible affiliate/store.

When all information needed for the campaign is obtained, the administrator may launch the campaign (534). Such a launch may include the step of making necessary fields, operations, methods, and interfaces available to members. It may also involve posting information about the campaign to web pages made available to members, and potentially to non-members.

The launch may further involve steps of contacting members to announce the campaign. Such contacting may occur by the vendor sending a message such as an e-mail message to people on the vendor's personal e-mail distribution list. For example, such addressees may include a band's fan club members. The vendor may send the message directly, e.g., by using promotional content for the campaign generated by administrator (including links that allow administrator to track purchases made under the campaign). Alternatively, the vendor may provide an e-mail list to the administrator, and the administrator may send out the announcements regarding the campaign.

The administrator during this period may be managing the campaign (536). After joining, a member may choose to purchase a song in the campaign (514) and the member may, as a result, be redirected to the affiliate/store site (504). There, the member may follow familiar steps for auditioning the content and may follow through by purchasing the offered content (e.g., a new album) or some of the offered content (e.g., a song on the album). When all selections have been made, the content may be delivered by the affiliate/store to the member, and the transaction may be confirmed. Such confirmation may involve the affiliate/store providing a communication to the administrator identifying the transaction, as discussed above.

When the administrator receives notice of a transaction, it may determine the number of allowable points and allocate those points, such as by relationships between the purchasing member and other members. The assigned points may then be posted to the accounts of each member. Also, if members complete certain goals needed to win awards (e.g., driving a certain number of sales in the early portion of a campaign), those awards may be released, and the administrator may cause the awards to be sent to members (538). Such a process may involve providing the vendor with identifying information for a member, where the vendor is to ship the items. Alternatively, where the administrator has its own inventory or where the prize can be transmitted electronically, the administrator may simply deliver or ship the item or items. The administrator may also transmit, either alone or in combination with the vendor, information to a third-party to effect shipment of prize merchandise. During a campaign, multiple members may join and multiple customers may purchase multiple songs on one or more occasions.

When a campaign is complete, or at another appropriate point, the administrator may tally up a total value of points for each member or may add additional points that have not already been assigned as part of the campaign (540). For example, bonus points may be awarded to members who reach certain goals that are set for a campaign, such as referring a predetermine number of users who purchased the content of the campaign, or referring a certain dollar value of purchases. Members may then redeem those points (518) such as to obtain items from various vendors, including the vendor that instituted the campaign, or from other sources. Such items may include additional content files, collectibles, tickets, or other materials.

Finally, each member of the system may receive relevant reports and statistical analysis (508, 524, 542). The reports may include information such as total sales from a campaign, conversion rates of a campaign, campaign depth, new member sign-ins for a campaign, sales breakdowns such as by merchandise type, distribution of awards based on participation, and reports on the above across campaigns and across administrator and affiliate stores.

Each of the use cases shown here may correspond to one or more processes associated with the use case. The following figures, for example, may describe one or more of the use cases in particular implementations.

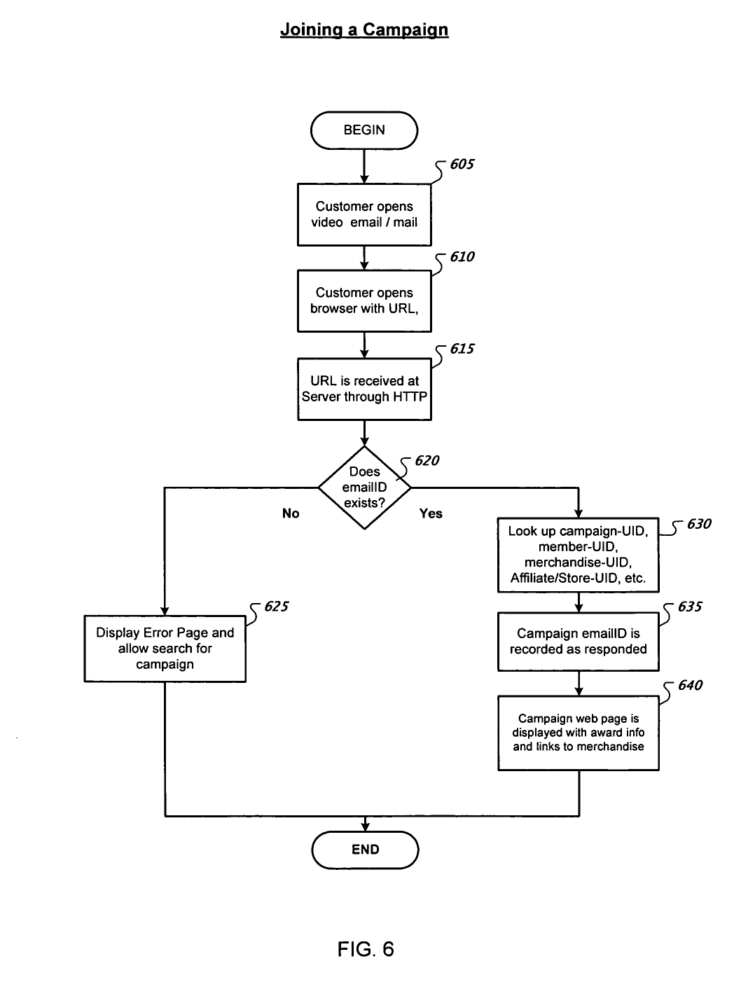

FIG. 6 is a flowchart showing actions taken by a member of a media distribution system in joining a campaign. It illustrates a customer opening an email or physical mail and following the included directions to join a campaign. When the customer follows the directions, he or she is directed to either an error page with campaign search functionality if the emailID in their URL (e.g., an identifier for the e-mail sent to the user or an identifier for the user, which can be passed with the HTTP request) does not exist, or they are directed to a campaign web page with award information and links to merchandise.

A customer begins joining a campaign by opening an e-mail or mail containing a Uniform Resource Locator (URL) text string, or similar feature (act 605). The e-mail may include or be liked to a video or audio presentation describing how to respond to the solicitation. The URL contains information that allows a computer or other electronic device that is linked to a network (such as the internet) to use a web browser to access content on another computer (termed a “server”) on the network (act 610). The customer may direct his or her computer to access the content specified in the URL by, for example, entering the URL into the browser, or in some cases clicking on the URL in a program that supports browser integration (act 610). This causes the information in the URL to be sent to the server specified in the URL.

Once the server receives the URL using a protocol such as HTTP or HTTPS (e.g., for secure web transactions) (act 615), the server may parse the URL to extract information such an emailID (act 620). The emailID may include an identifier for the particular user or that identifies the e-mail sent to the user that can be traced back to determine the identity of the user.

If the emailID does not exist, a response is sent to the customer's computer causing it to display a page with an error message and that allows the customer to search for a campaign (act 625). Such action may occur, for example, if the campaign has ended, has not yet started, or if there are problems with the campaign or with the URL received by the customer. If the emailID does exist (act 620), the server looks up information such as the campaign-UID, member-UID, merchandise-UID and affiliate/store-UID 630. The campaign-UID is the unique identifier in the system for a particular campaign. The member-UID is simply a unique number or alphanumeric indicator that is used to identify each member of a system. The merchandise-UID is the unique identifier in the system for a specific type of merchandise, e.g., 1033i7733 identifies guitar picks from Ry Cooder. The affiliate/store-UID is an indicator that informs the system of the preferred affiliate/store for a particular user. The affiliate/store-UID may be consulted before redirecting a member, so that the member buys content from his or her preferred on-line store.

After looking up the various UID information, a system such as the administrators discussed above may record the campaign emailID as responded (act 635). Marking the e-mail with a response flag allows the system to know which campaigns were responded to by individual members, thus allowing for determination of a response rate. Finally, a campaign web page is sent to the customer's computer displaying award information and links to merchandise (act 640). For example, the web page may show users everything that is available for purchase through the campaign, what could be obtained with bonus points, and the point allocation for the campaign. In this manner, the users/members may determine whether they want to make recommendations as part of the campaign (e.g., if the point allocation is favorable to them), can see their accrued points and their progress toward reaching certain awards, can see particular steps they can take to reach particular award levels, and can select awards where they have tallied enough points (expressed, e.g., in terms of numerical points, dollar values, units of other measure, or as levels in a process or system, among others).

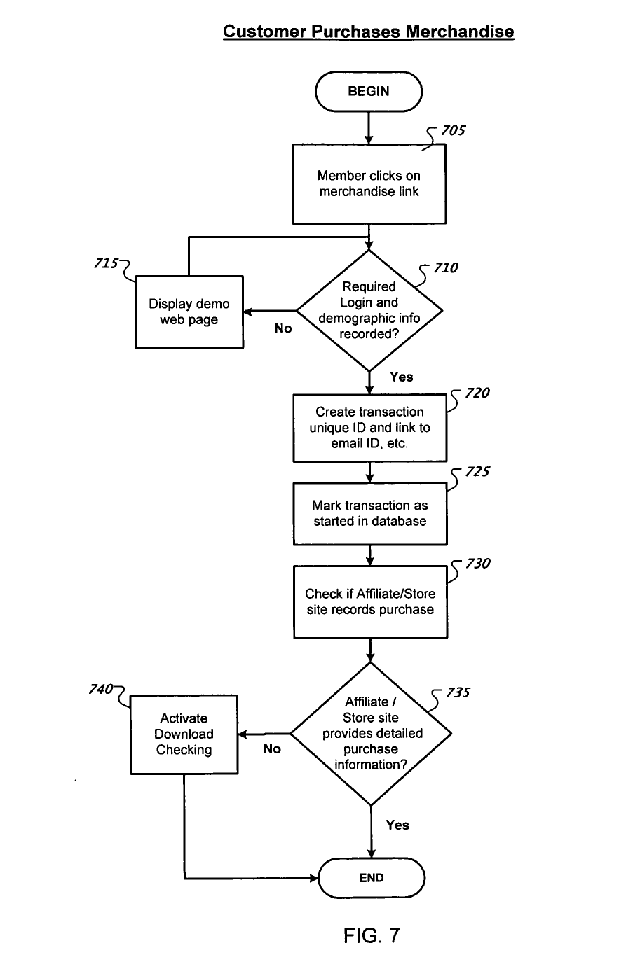

FIG. 7 is a flowchart showing a purchase of merchandise by a member. In general, the process involves a member choosing to view merchandise, the identification of the member with a transaction, and follow-up to determine whether the member has completed the transaction and what was purchased in the transaction.

Initially, a member starts by clicking on a merchandise link, which may be contained in an e-mail (such as an HTML e-mail) that has been delivered to the member or on a web site to which the member has been directed (act 705). The merchandise may represent electronic content such as music or movies that the member may purchase for download. The particular actions to be handled by an administrator as opposed to an affiliate is not critical, and the particular activities may change depending on the make-up and sophistication of each party. The system may determine whether appropriate information about the user has been recorded (710), and may display a demo page or a page that permits the user to provide such information (715). If the information can be located, then transaction information is created (720), and the database is marked by the administrator to indicate a started transaction (725). The administrator may then check to see if a related affiliate or store has recorded a related purchase (730).

Upon checking with the affiliate or store, the administrator may check to determine whether the affiliate or store has provided sufficient purchase information (735), and if it has, the use case ends. If it ha snot, download checking by the administrator may be employed (740).

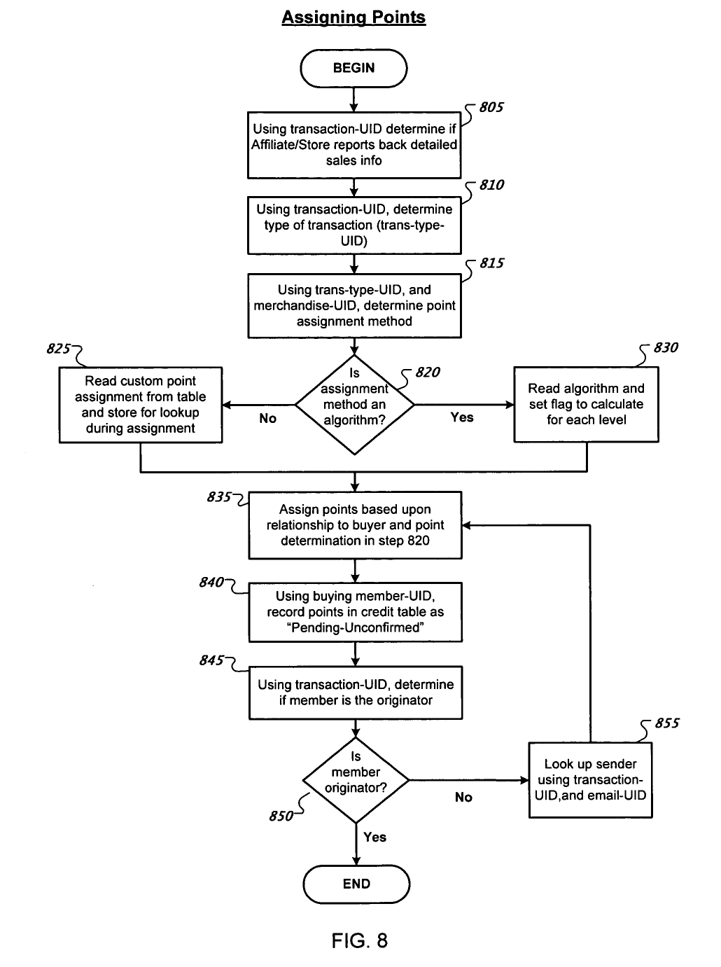

FIG. 8 is a flowchart showing the assignment of points to members of a media distribution system. In general, the system first obtains information about a transaction that has been processed by an affiliate/store, determines the point allocation scheme to use for the transaction, and then allocates points accordingly.

At acts 805, 810, and 815, the system looks to a transaction-UID to make certain determinations. The transaction-UID is an identification number that uniquely identifies each transaction and ties the transaction to a particular member of the system.

The use of the transaction-UID begins by an administrator generating a transaction-UID when a member goes to an affiliate site after joining a campaign. In act 805, the system determines if an affiliate/store reports back detailed sales information. Such reporting back may occur by XML or EDI messaging or via other appropriate mechanisms. The determination is made by setting a flag for the affiliate in the administrator database.

If the affiliate/store does report back information, the system in act 810 may determine the type of the transaction. This determination is made by analyzing a trans-type-UID variable obtained from the administrator system, originally entered by the administrator. The variables may record whether the transaction related to the purchase of a single piece of merchandise or a bundle of merchandise. The variable, in this example, is set when the user clicks through on the administrator public campaign website so that different kinds of transactions may be recorded, and is created, for example, by an administrator when the campaign starts.

At act 815, the system may look in a database for an entry that contains the appropriate merchandise-UID and trans-type-UID to determine a point allocation or assignment approach. These two variable may be used, as they uniquely identify a point value to be assigned. Various point assignment approaches may be stored in the system, either as generated by the system, generated by particular vendors, generated by vendors from point assignment templates provided by the system, or in other appropriate manners.

At act 820, the system determines whether the point assignment is algorithmic or another form of assignment, such as a discrete assignment, including assignment that uses a look up table. An algorithmic assignment approach generally involves using one or more formulae for assigning points, into which the characteristics for a particular transaction or group of transactions can be plugged, in order to compute point awards. Other assignment methods—termed discrete methods here—may simply involve pre-assigned point amounts or ranges being provided to members associated with a transaction. Hybrid point assignment techniques may also be employed. For example, a discrete approach may assign point ranges, and algorithmic approaches may assign particular points within the ranges.

If the assignment method is algorithmic, then the system reads the algorithm and sets a flag so that the particular points are calculated for each level, such as each level of relationship to the person making the transaction (act 830). If the method is not algorithmic, the system may, for example, read point assignments from a table and store them for later look up during point assignment. For example, an artist may pre-determine (either independently or using a profile provided by an administrator) that a buyer should receive thirty percent of all points, a referrer, or originator, should receive fifty percent, and a first-generation relationship should receive twenty percent. If one of the members is absent from a transaction, the remainder of points may be forfeited to the system, may be spread across the members who are present, may be awarded to a particular member (e.g., the purchaser), or may be awarded in a different manner as appropriate.

At act 835, the system assigns points for relationships to the buyer. For example, the member who originally caused the buyer to join the system may receive points, and the member who caused that first member to join may also receive points. The points may decrease the further from the buyer that the relationship spreads, and may also decrease the further in time since the buyer was recruited to the system. At first, these points may be recorded as “pending-unconfirmed.”

The system may then determine if a member is the originator for the transaction (acts 845 and 850), using for example, the transaction-UID. The system steps up through the chain of referrers, awarding points at each level, until it reaches a level for which the user was not referred, and is thus the originator. If the member is not an originator, then the system looks up the sender of the campaign using the transaction-UID and email-UID (act 855), which, respectively, link back to the email-UID, and include the PersonID of the campaign sender.

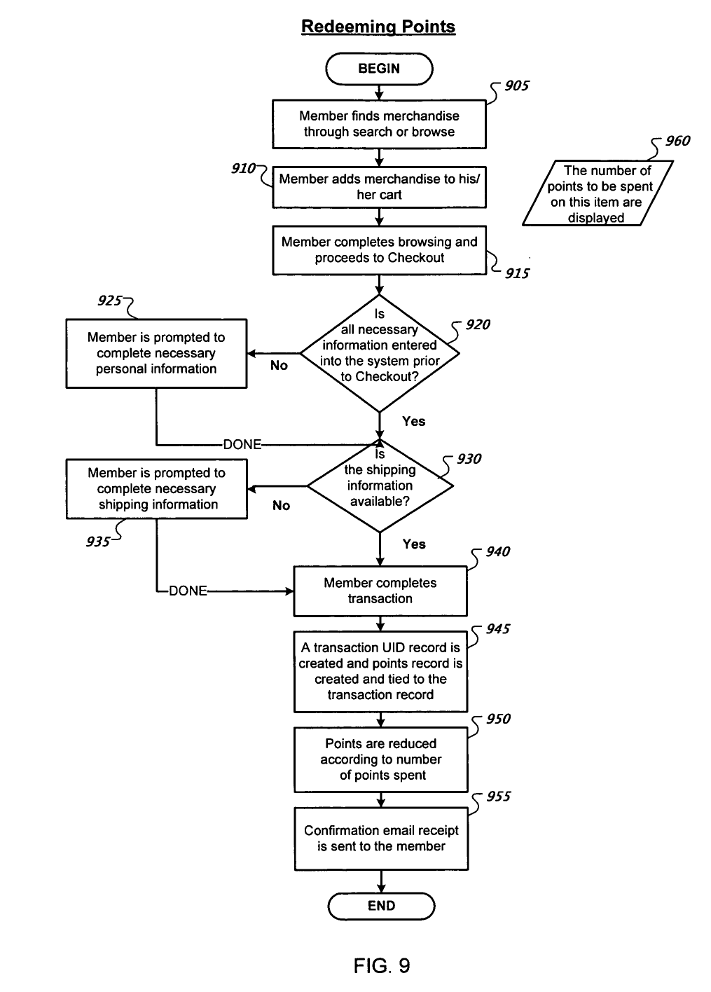

FIG. 9 is a flowchart showing the redemption of points by a member. In general, a member may use a shopping analogy on a web page to select merchandise on which to “spend” points, may confirm their points available and the point “cost” of the merchandise (which may include physical merchandise that generally requires shipping, and electronic merchandise that may generally be downloaded), and may confirm that the merchandise is desired. A system may then record the transaction, deduct the appropriate number of points from the member's account (perhaps combined with charging the member some amount of money, either by deducting it from an account or obtaining payment such as by credit card or electronic payment, e.g., PayPal).

The member first finds merchandise through searching or browsing (act 905). Such location of merchandise may occur through familiar mechanisms of providing menus and screens of images classified by merchandise type, artist, etc. Also, searches may be permitted, and merchandise carried by other entities may be shown, such as when an administrator has a cooperative shipping arrangement with those other entities. For example, to avoid having to stock and inventory merchandise, an administrator may form agreements with companies that otherwise carry like merchandise, and may redirect members to the other company's web site, may show catalogs of merchandise kept by the other company through the administrator's interface, or may take orders on its own site, and then refer fulfillment of the orders to the other company.

At act 910, the member adds merchandise to his or her cart, using a familiar shopping cart analogy for on-line shopping. Other such paradigms for permitting a user to select merchandise may also be used. When the user completes browsing for and selecting merchandise, they proceed to a checkout (act 915). A check is made to determine whether all necessary information is entered into the system before checkout 920. For example, the information may include an ID or password to log into a particular site, and may require demographic information to participate in a campaign. If all necessary information is already entered or known, the process moves on. If all necessary information is not already entered or known, the member is prompted to complete necessary personal information (act 925).

A determination is then made as to whether shipping information is available for the member (act 930). If it is not, the member is prompted to complete the necessary shipping information (act 935) before completing the transaction (act 940). If the information is available, the user moves to completing the transaction (act 940)

The completion of the transaction may include various steps, depending on the circumstances. For example, where a credit card or other payment is needed (e.g., if the user does not have enough points alone to acquire the merchandise), the user may be prompted for such information. The user may also be asked to confirm all of the information previously entered, and the system may check the information to ensure that it does not violate any data-type rules or lack any necessary information. In addition, the user may be prompted with special promotions based upon the merchandise that he or she has acquired. For example, where a user purchases items from a particular band, and has also purchased sheet music from other bands in the past, the system may ask the user whether he or she would also like to purchase sheet music—whether for money or for non-monetary points.

After completing the transaction 940, transaction UID and points records are created and tied together to the transaction record (act 945). By this connection, the system may further assign the particular points allocation, merchandise shipping, and posting to the particular vendor so that proper bookkeeping occurs and so that follow up on the transaction may occur (e.g., if the member does not receive the requested merchandise). Points are then reduced according to the number of points spent 950, and a confirmation email receipt is sent to the member (955). The confirmation email may include a confirmation number, which may be the transaction UID or may correspond to the transaction UID.

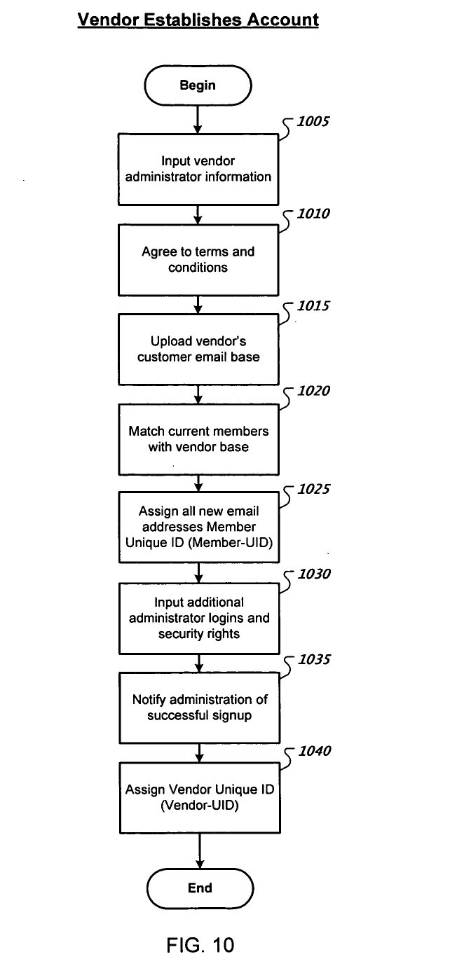

FIG. 10 is a flowchart showing actions taken by a vendor in establishing an account with a media distribution system. In general, the process involves a vendor identifying itself, agreeing to terms, and providing information such as identifying information for members to which it would like to send content.

The vendor begins by inputting vendor administrator information 1005. Such information may include contact information for the administrator to use in resolving problems, as some vendors may handle distribution themselves, while others will work through an agent or other representative. In addition, a vendor may provide information identifying its library of work, which may include filling out a web form or providing XML messages in a predetermined format listing albums names and song names. Alternatively, the vendor may direct the system to public sources that contain such information (such as iTunes directories and the like).

The vendor then agrees to terms and conditions 1010. Such terms and conditions may include items such as granting of copyright licenses (e.g., for musical snippets the administrator may pay), agreements regarding obligations to provide shipments of merchandise awarded by an administrator, waivers of liability, agreements to bond certain amounts to cover such shipments, and other appropriate provisions.

The vendor may also upload its e-mail base to the administrator (act 1015); current music distribution system members may then be matched with the vendor base (act 1020). E-mail addresses that do not match may be given new member-UID's. As described more fully above and below, other information may be related to these UID's if and when such prospective members choose to join as actual members. In such a situation, information such as a member's shipping address, full name, credit card numbers, and content preferences may be obtained, along with other information.

Alternatively, a vendor can provide user identifiers to the system that do not provide the system with the ability to contact members directly. In such a situation, the vendor may create an ID that corresponds to each e-mail address or member in its system, and may pass the ID to the system. The system may in turn associate the ID with a new member-ID, and return to the vendor information that permits the member-ID to be associated with a user who contacts the system. The vendor may then send messages directly to its e-mail list or lists, and may embed the identifying information, which may be the provisional member-UID or related information. That information may be embedded within a link in the e-mail so that when the user recipient clicks on the link—if they are interested in the promotion—the information may be conveyed to the administrator so that the administrator can determine that the user accessing it corresponds to the particular member-UID. The accessing party may then provide additional information, as described above, and the system may associate that additional information (which may include the member's actual e-mail address) with the member-UID. If the obtained e-mail address or other information matches someone who is already a user, the member-UID created for the particular vendor may be deleted and the member associated with the pre-existing member-UID. In this manner, most of the advantages of the other distribution methods may be achieved, with the vendor maintaining some control over, and privacy for, its particular contacts.

At act 1030, additional administrator logins and security rights are input by a vendor, such as by identifying workflow permissions, e.g., certain people who may add creatives to a campaign but not approve them, and others who are allowed to approve but not add content. When all items are completed properly, the process may notify the administrator of successful sign up of the vendor. At this stage, a Vendor-UID that is unique to the particular vendor may be assigned (act 1040). This Vendor-UID may be used in the future to verify the identity of anyone attempting to log on as the vendor, and to associate the vendor with various forms of data and with various campaigns and transactions.

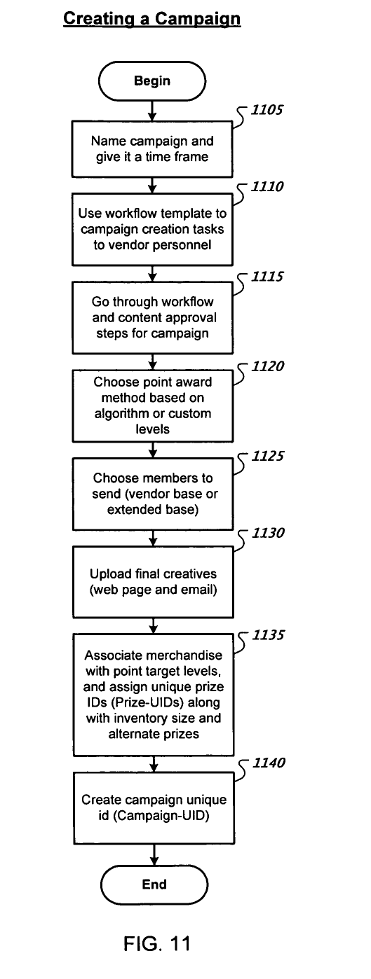

FIG. 11 is a flowchart showing actions taken by a vendor in creating a campaign.

Initially, the campaign is named and given a time frame 1105. In general, a vendor (or someone related to a vendor such as an agent) identifies a campaign they would like to create (though other entities may also institute a campaign, including administrators). They then follow a workflow through a number of web-presented forms and screens to select point assignment methods for the campaign, members to be presented with the campaign, and merchandise to be distributed to those who take part in the campaign. As with the other figures and flows described here, the particular order of execution that is shown is exemplary only, and other appropriate orders of execution may be used. Also, steps may be removed, and other steps may be added or used in place of those depicted.

At act 1105, a vendor first names a campaign and gives it a time frame, such as the time the campaign is to start and stop. During the time frame, members may purchase content and other items (such as custom merchandise, including collectibles), and various members may accrue points from those purchases. In addition, members may redeem the points for other merchandise during the campaign, though they may also do so after the campaign ends (but perhaps for a limited amount of time). Time in this context may be measured by clock time or other measures of time, such as the time it takes for all the merchandise in a campaign to be exhausted. Thus, where a band has only 100 signed T-shirts and wants to award a T-shirt to every member that drives the sale of ten albums, the campaign may be measured by the time it takes for 100 members to drive the sale of ten albums—however long that is in clock (or calendar) time.

The vendor may then use a workflow template to give the campaign a name such as “New Album—Yo Yo Ma sings Jerry Garcia,” and then give a start date and end date (time frame). Other appropriate information for operating the campaign may also be sought through the workflow, and the appropriate databases updated when the information is received.

At act 1120, a vendor chooses a point award method. As described above, the points may be computed in a number of manners, including by an algorithm or discrete defined levels of points for various activities and relationships. Also as described above, a user at act 1125 may identify members to whom notice of the campaign should be sent. The members may be part of the member base of the system, or may be part of an extended base, such as a fan club associated with the vendor.

At any appropriate point during the campaign creation, the vendor may also be permitted to upload so-called “creatives” for the campaign (act 1130). Such creatives may include promotional images and sound files, including web pages, e-mails, HTML content for e-mails, and the like. At act 1135, the vendor is permitted to define how awards are to be awarded, particularly by identifying the award merchandise, which may also involve providing information about the merchandise and images of the merchandise (e.g., photos for physical merchandise and electronic album covers and the like for electronic merchandise). The vendor may also assign unique prize IDs for each piece of merchandise or may use pre-assigned IDs, such as when the vendor has sponsored previous campaigns. Thus, for example, a vendor may define that a copy of a signed poster be awarded for 1000 points, a souvenir t-shirt for 10,000 points, and concert tickets for 100,000 points. The vendor may also identify special prizes to be awarded, such as a free trip to a random member selected from among the top 10 point-getters.

When the vendor is entering contest rules, the system may provide particular parameters and limits. For example, the system may provide parameters in the form of campaign templates, by which the vendor may enter certain information about a campaign and the system may suggest other information consistent with that entered by the user, as necessary to provide sufficient detail for carrying out a campaign. The system may also present a number of complete campaigns as templates, and the vendor may simply select a campaign, and then be prompted to enter customizing information, such as prize identifiers. Limits may be provided by the system, such as to prevent a vendor from creating a campaign that is larger than the vendor can support (e.g., if the vendor's size or experience is reflected by the system). Also, the system may provide legal limits, so that the vendor is steered toward creating a campaign that is consistent with the laws of the various states.

Finally, as mentioned above, the campaign can also be defined by the availability of awards, e.g., so that 10 awards are provided regardless of how many points members accrue (e.g., with the top 10 point-getters getting the awards). Such a method has the advantage of serving as a limit to the amount of merchandise a vendor must supply. Such predictability may also be provided by defining the campaign to end when the awards are exhausted. In addition, a vendor may define alternative awards to be provided if the primary awards are unavailable or run out. When the necessary information about a campaign has been entered, the system creates a unique campaign ID to uniquely identify the campaign within the system (though such ID creation may occur at the outset of the campaign creation process).

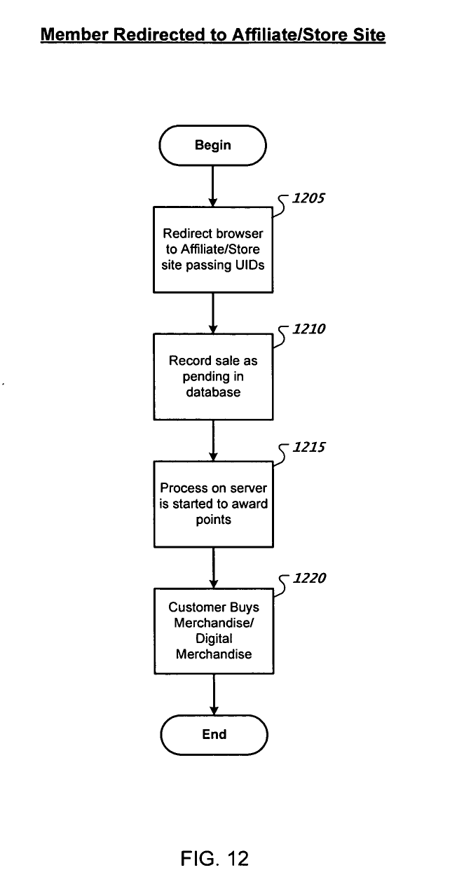

FIG. 12 is a flowchart showing the redirection of a user to a media distributor. In general, an administrator or a similar system may receive a request from a user (e.g., from the user's web browser or by selection of a link in an e-mail), and may then forward the user to an affiliate/store along with information that identifies the user as relating to the administrator. Such information can then be used to ensure that the administrator is notified about resulting purchases by the member, and can be given information to credit the member with the purchases.

At act 1205, a system redirects a user to an affiliate/store web site, for example, after receiving a request from the user, such as from the selection of a hypertext link in a mark up document. While the user is viewing the offerings from affiliate/store, the system may create a new entry in its database that identifies a potential purchase and records it as pending. The system may also look up preliminary information needed to award points, as discussed above, for any subsequent transactions. (Such preliminary steps may also wait until after a purchase is completed.) At act 1220, the member buys merchandise. Upon the purchase with the affiliate/store becoming complete, confirmation information may be returned to the system. Such transfer of information may occur, for example, by XML transmission from affiliate to administrator. The open transaction may then be closed, and points may be awarded according to the rules for the campaign (which rules may also be common across multiple campaigns or multiple products outside a campaign).

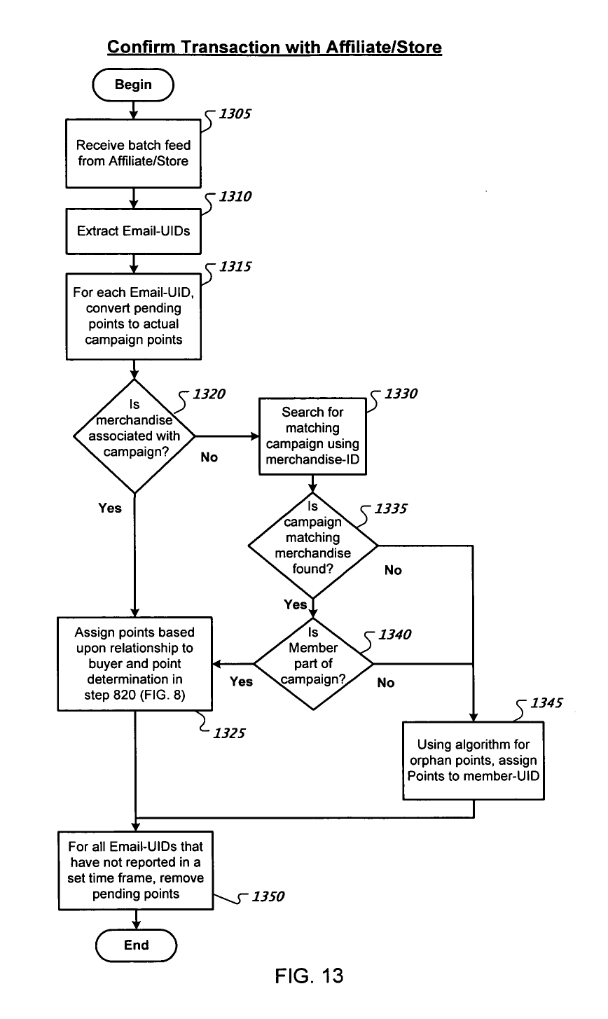

FIG. 13 is a flowchart showing confirmation of a transaction with a media distributor (such as an affiliate/store). In general, the process involves a distributor sending transaction reports to an administrator, along with identifying information for each of the members. The administrator may analyze that information to determine what members have made purchases and how much they have purchased. Analysis of the content of the purchases may also occur, and follow-up operations may be instituted to, for example, recommend similar merchandise for a member to acquire.

A batch feed is first received from an affiliate/store (act 1305), and email-UIDs are extracted (act 1310). The feed may be generated automatically, such as on a time-recurring basis (e.g., each night), and may contain information about a number of transactions, in batch mode. The email-UIDS may represent an email sent to a particular person by another particular person (or on behalf of that other person) for a particular campaign. The system may then check for open transactions, and may allocate points to members associated with any related open transactions, or may convert already-allocated points to actual, allocated campaign points to which the member has access.

Merchandise acquired through these transaction may or may not be associated with a campaign, e.g., the member who bought the merchandise may not have accessed the affiliate/store through a path, or used a mechanism, that would allow the affiliate/store to provide information that would link the purchase to a particular campaign or campaigns. If merchandise is associated with a campaign (act 1320), points are assigned (act 1325) based upon member's relationships to the buyer and a relevant point determination. Such points are also assigned if the merchandise is not associated with a campaign (act 1320), but is instead merchandise addressed by a campaign, so that it may be inferred that the purchase of that merchandise relates to the campaign (act 1335), and points may be awarded to a member and related members if the member is part of the campaign (act 1340).

If the merchandise does not match up with a campaign (act 1335) or the member is not part of the campaign (act 1340), the remaining points may be treated as orphan points and may be allocated accordingly. For example, a user may buy merchandise from an affiliate beyond what is promoted in a campaign; such additional purchases may also be reported and may in appropriate circumstances result in the award of points to the user and users related to the user. For example, all points may simply go to one member, such as the buyer of the merchandise. Alternatively, the points may be allocated in a manner similar to other points.

As part of receiving transaction information and tracking open transactions, the system may also check periodically for open transactions, and may remove pending points that have been awarded pro forma, if a sufficient time has expired to conclude that the particular transaction did not complete (act 1350)

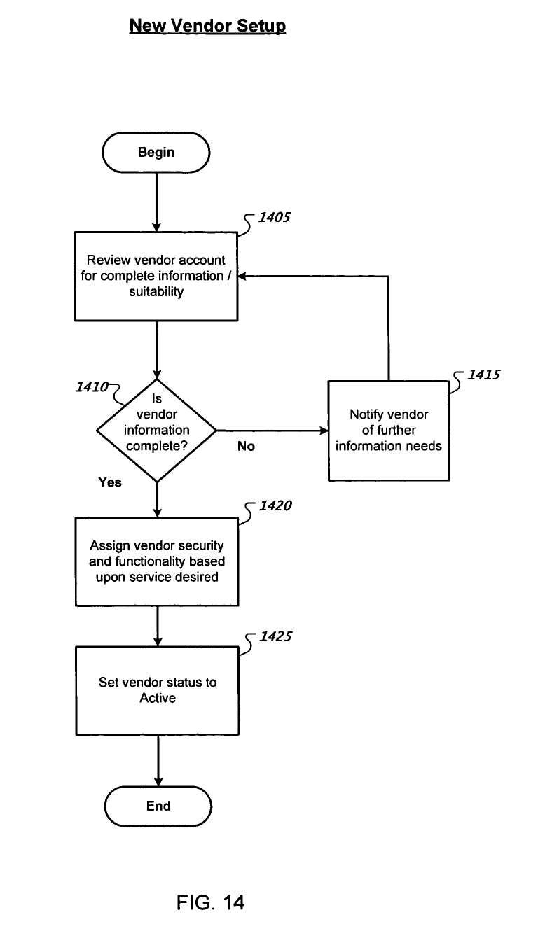

FIG. 14 is a flowchart showing actions for establishing a new vendor with a system. In general, the process involves an administrator reviewing information submitted by a vendor and configuring a vendor account with the supplied information. Upon configuring the vendor account, the administrator then activates the account.

At act 1405, the administrator checks the information supplied by a vendor, as described above, to determine whether the vendor administration information is complete and/or suitable. Examples of vendor administration information may include vendor contact information, album listings provided in XML, and other appropriate information for defining an account for a vendor. The administrator may review the vendor administration information for suitability, for example, by sending a test message to the vendor using the supplied contact information or ensuring that the album listings are properly encoded. A vendor may also be required to review a terms of service page or document, and to indicate acceptance of the terms of service before the system will provide further access to the vendor.

If the vendor administration information is found to be not complete and/or not suitable (act 1410), the administrator attempts to contact the vendor using the supplied contact information (act 1415), and indicates to the vendor the issues that need to be resolved by resubmitting, adding to, and/or modifying the information that had been supplied by the vendor. If the administrator is not successful in contacting the vendor, the account may be placed on a hold status, waiting until the vendor attempts to sign on again.

If the administrator determines the vendor administration information is complete and suitable (act 1410), the administrator may set parameters in the vendor's account such as security and functionality (act 1420). Security features may include restricting a user's ability to log in to a site or log in to a particular campaign, and otherwise restricting user access. Functionality set by the administrator may include restricting the ability to create or start campaigns. When the administrator is finished setting security and functionality, as described above, the administrator changes the status associated with the vendor's account to make it active (act 1425), making the account “live” and available for use by the vendor.

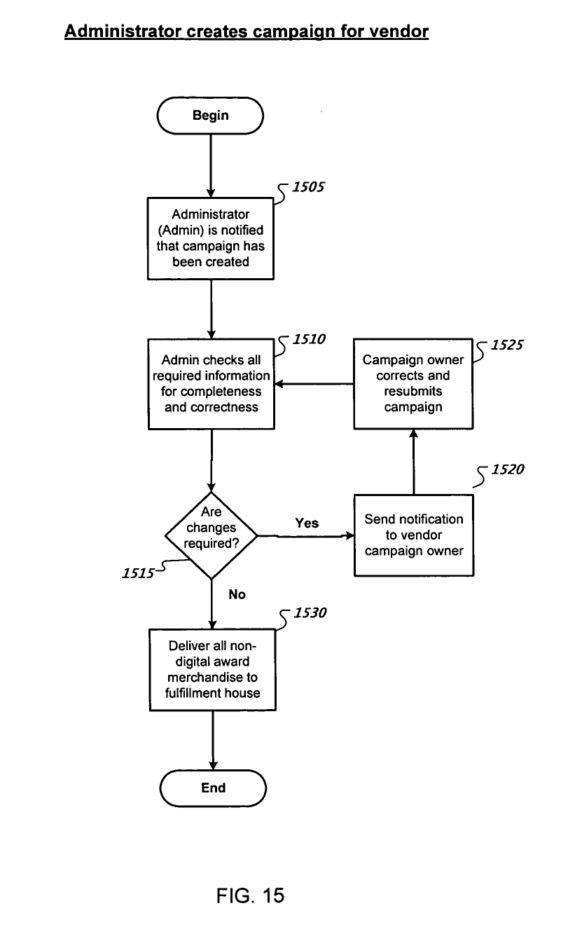

FIG. 15 is a flowchart showing the creation of a campaign by an administrator. In general, the process involves, when an administrator receives notice of the creation of a new campaign by a vendor (act 1505), checking campaign information entered by a user to ensure that it follows an appropriate format and contains all required information (act 1510). If changes are required (act 1515), the campaign owner is notified and allowed to correct any problems, until all corrections are made. When the campaign is properly established, the administrator may deliver all physical merchandise to a fulfillment house, or may have the vendor deliver it to the fulfillment house. The administrator may also stock some or all of the merchandise (particularly when it is in an electronic form). The use of a fulfillment house for physical merchandise may have the advantage of significantly reducing or eliminating the inventory requirements for the administrator.

Initially, a music distribution system administrator is notified that a campaign has been created 1505. The administrator checks all required information for completeness and correctness 1510. If it is determined that changes are required 1515, notification is sent to the vendor campaign owner (act 1520); the campaign owner then corrects and resubmits the campaign 1525 for re-checking by the administrator 1510. If no changes are required 1515, all the non-digital award merchandise may be delivered to a fulfillment house (act 1530). The fulfillment house may be, for example, an organization under contractual obligation to store the merchandise and deliver it to members as instructed by the administrator. The fulfillment house may be bonded or may provide another form of security or guarantee that the merchandise will be delivered or that adequate compensation may be obtained. The administrator may structure the terms of its agreements with its members in a manner that matches its agreement with its fulfillment house or houses.

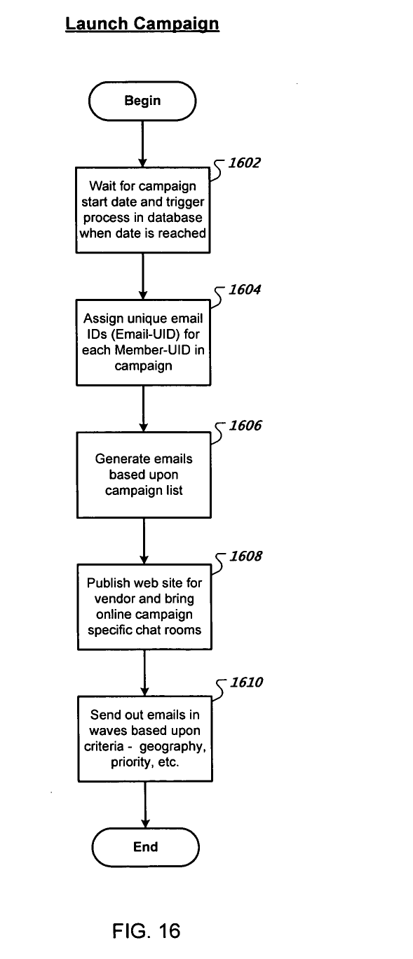

FIG. 16 is a flowchart showing actions for launching a campaign. In general, when a start date stored by the administrator fires, the administrator generates e-mails for the campaign, sends the e-mails to designated recipients, and brings a campaign web site online.

As shown in FIG. 16, the administrator initially waits for the campaign start date specified by, for example, the vendor upon establishing the campaign (act 1602). On the starting day of the campaign, the administrator triggers a process that accesses a database storing information about the campaign and members associated with the campaign (act 1602). The administrator assigns a unique email ID to each member-UID in the campaign (act 1604), which allows email associated with each member targeted during the campaign to be tracked when a member responds to the campaign. Associating a unique email ID with each member UID allows a plurality of campaigns by a plurality of vendors to generate reports and statistics on a plurality of members, independent of other vendors and campaigns. Reports and statistics based on unique email IDs may be used, for example, to judge the efficacy of marketing tactics used during the campaign without providing private member information.

Email is generated based upon a campaign list (act 1606), which may be a list of members whose profiles show interests common with the campaign. For example, certain members may have indicated that they are interested in heavy metal music or have purchased large amounts of heavy metal music in the past, and can then be included in lists for launches of new heavy metal music. The campaign list may also be sourced in whole or in part from the vendor itself—such as a list of fans, as described more fully above.

The administrator then publishes a website for the vendor that is customized for the campaign (act 1608). The website may have integrated or stand-alone components such as chat rooms or blogs, for example. The website may have been previously prepared, may be generated dynamically using information already provided by the vendor, or may be created in other manners. Information about the campaign may also be included on a more general web page that shows information about many campaigns, with links to particular campaign pages or other landing spots. In addition, campaign information may be displayed as part of an application separate from a web browser.

At act 1610, the email generated in step 1606 is transmitted. The email may be sent out all at once or in groups based on specified criteria such as geography, buying history, or another priority. For example, it may be sent first to preferred members, such as members who have generated the most points from their relationships. By sending the e-mail in waves, one can produce staged campaigns, e.g., where platinum-level members have a first chance, followed by gold, silver, and regular members. Such an approach may ensure that higher level members have more opportunities to become referrers, and also may help generate “buzz” for a campaign.

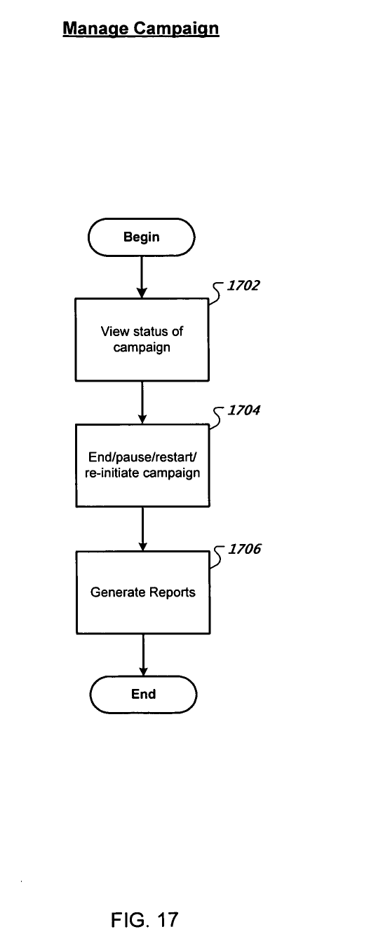

FIG. 17 is a flowchart showing actions for managing a campaign. In general, by the actions, an administrator may view information about a campaign, manage the campaign's state, and/or generate reports about the campaign.

The flowchart shown in FIG. 17 shows an example of how management activities may be arranged. In this example, an administrator (in this case, the person running the administrator system) may view the status of a campaign to determine whether it is active, ended, or in another state (act 1702). This may be useful, for example, if multiple campaigns are being run, or if a campaign needs to be halted prematurely, or to check saturation level for members. An administrator may also review a combined report showing all active campaigns and their current states, including the amount of merchandise ordered under each, and the time remaining in each campaign. Upon viewing the status, the administrator may choose to perform an action (act 1704) such as ending a campaign if it is wholly inactive or if its merchandise has become or is about to become exhausted, or pausing an active campaign if members have been saturated by similar campaigns, or if more award merchandise is being acquired. Once the issues are resolved, the administrator may resume a paused campaign or even re-initiate a campaign.

An administrator may also generate reports (act 1706), for example detailing all orders under a campaign, or summarizing the number and amount of orders based on source (e.g., original recipients of e-mails, members recommended by others, etc.). Other reports, as discussed above, may also be generated.

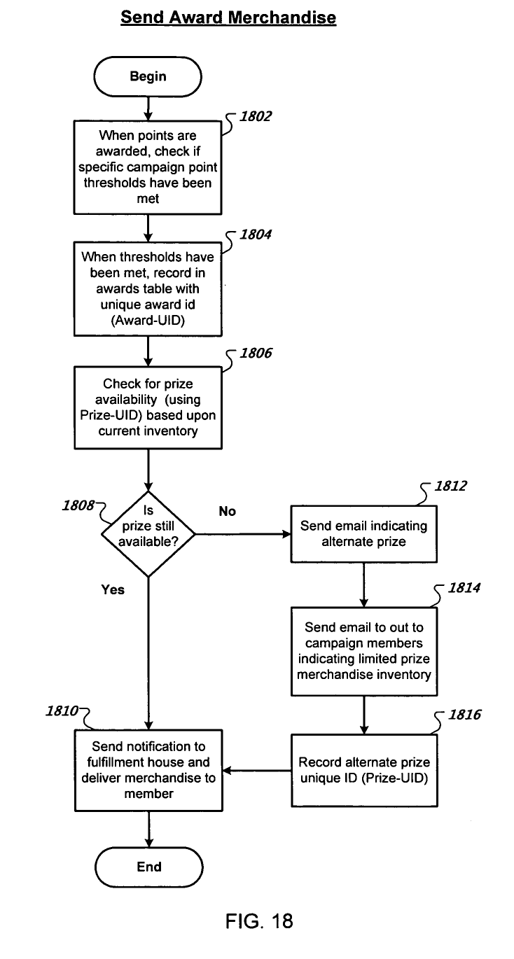

FIG. 18 is a flowchart showing actions for sending items of value as a reward to system members. In general, when the points accumulated by a member reach a specified threshold, the music distribution system sends a notification to a fulfillment house indicating that the specified merchandise is to be delivered. If the specified merchandise is no longer in inventory, alternate merchandise may be selected. Notifications are also sent to the merchandise senders and receivers indicating the substitution. Award delivery may be delayed until accepted by a user, such as when a user may want to hold off until they have accumulated enough points for a higher value item of merchandise.

When points are awarded, the administrator checks whether the point totals specified for the campaign have been met (act 1802). If the threshold has not been met, the campaign simply continues (not shown). When the thresholds have been met, the unique award ID (award-UID) is recorded in an awards table 1804. The unique award ID may be used to uniquely track an award of merchandise, such as to coordinate with the fulfillment house and to connect back to the user account so as to debit the account for the points represented by the merchandise.

The system then may determine whether the prize specified by the prize-UID when the campaign is started (act 1135) is available in the current inventory (act 1806). If the prize initially specified by the prize-UID is available, notification is sent to the fulfillment house to deliver merchandise to the member (act 1810). The fulfillment house may then deliver the merchandise.

Follow-up mechanisms may also be provided for verifying that merchandise has been delivered successfully. For example, the fulfillment house may follow an electronic tracking number associated with a shipment (e.g., FedEx or UPS number) and may report back to the administrator that a delivery is complete when the system associated with the tracking number shows successful delivery. Alternatively or in addition, the administrator may be provided with the tracking number and may monitor the progress itself, and may mark a shipment as successfully completed when the system associated with the tracking indicates such status.

However, if the specified prize is not available, an alternate prize is substituted. First, the administrator sends an email to the member receiving the award that indicates an alternate prize is being issued (act 1812). An email may also be sent to other campaign members indicating that available prizes are limited (act 1814). This allows other campaign members to understand what prizes or rewards they are working toward. The alternate prize unique ID (Prize-UID) is recorded (act 1816) by an administrator before sending the notification to the fulfillment house (act 1810).

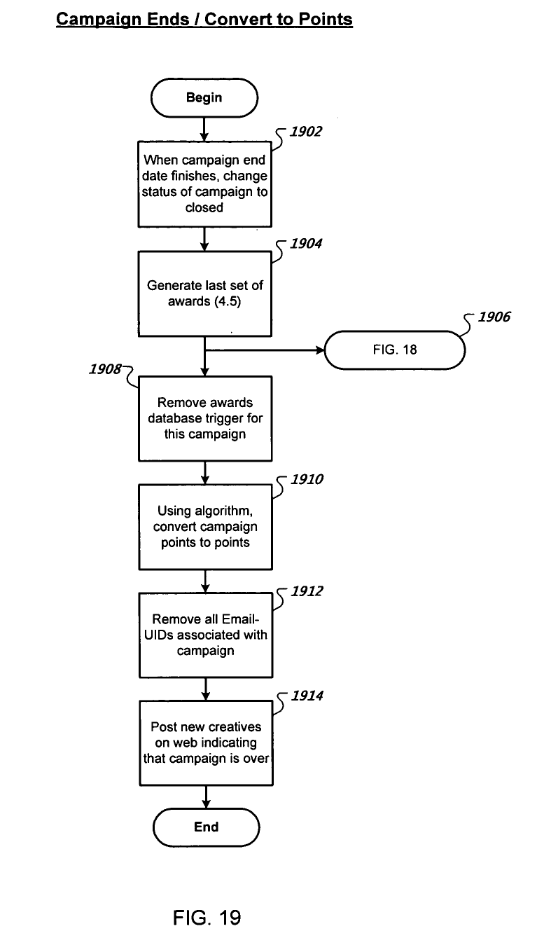

FIG. 19 is a flowchart showing the ending of a campaign and the provision of points to members. In general, the administrator closes the campaign at the end of its term and ensures the awards have been generated and sent. The administrator also halts the awarding of points and posts information to the web site that indicates that the campaign is finished. Furthermore, the administrator computes point totals, and closes out remaining files relating to the campaign.

When a campaign end date occurs, as specified by the campaign parameters (e.g., established by the vendor), the administrator changes the status of the campaign to “closed” (act 1902) so that no further activity within the campaign may occur. The administrator then generates the last set of awards (act 1904), such as awards given to highest performers during a campaign and the like (i.e., awards not triggered solely by reaching a certain point level). For example, the top ten performers in a campaign may receive a particular award. The administrator then causes those awards to be distributed (act 1906; see FIG. 18). The administrator may also trigger the delivery of all awards, where a campaign is established so as to hold all awards so that they can be shipped more efficiently en masse at the end of a campaign.

In conjunction with or after the final awards are sent (act 1906), the administrator may remove the trigger from the awards database to prevent the awarding of additional points (act 1908). The removal of the trigger may be propagated to other components of the system so as to prevent any messages or other indications from being sent to members that would lead them to believe that they are accruing points for orders made out-of-time.

Remaining campaign points that are not exchanged for awards as indicated in further detail above, are converted to a more general form that allows the members to take advantage of residual points left over after multiple campaigns. Various algorithms may be used to convert the campaign points to generic points (act 1910), such as giving each upstream member (1/(2̂n))*p points, where n is the number of the level in the chain and p is the points.

After point conversion, the administrator removes all email-UIDs associated with the campaign (act 1912) from the database, so as to prevent degradation in the performance of the system. The administrator also places creatives, such as banners or overlays announcing the end of a campaign on the campaign website indicating that the campaign is over (act 1914).

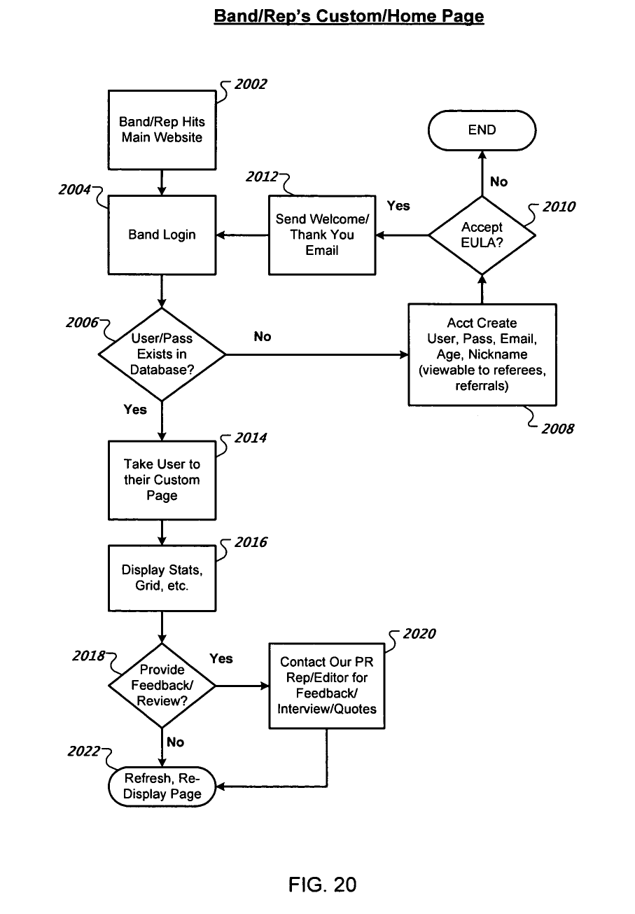

FIG. 20 is a flowchart showing the creation and maintenance of a home page for an artist. In general, the artist can visit the main music distribution system website, operated by the administrator. Upon logging in or otherwise presenting credentials, the artist is presented with his or her custom web page. The artist is also provided a means to send feedback to the administrator about the web page. A number of tools may be made available to the artist for adding components to the web page and otherwise customizing it. For example, the artist may select background colors consistent with the artist's main promotional colors (e.g., black for many bands). Other automated tools for creating mark up documents may also be provided, and may be directed toward particular issues with implementing a page for an artist. For example, special menu selections may be provided for adding links to musical snippets and the like.

The administrator may also impose certain limitations on the pages created by artists, and may create exemplary pages for artists. Such limitations may be helpful, for instance, when the administrator wants to keep a consistent and familiar interface for its users, so that, for example, artist information is always displayed in a particular manner, snippets of content are made available for review in another area in a common format, and other components are also presented consistently (though with room for some customization). Alternatively, the administrator may provide varying levels of interaction that permit different levels of customization. For example, new or small vendors may be guided and provided with less flexibility, whereas larger and/or more sophisticated artists may receive more flexibility.

Initially, the artist or his/her representative visits the music distribution system website (act 2002) using a web browser. By choosing the appropriate icon or link, for example, the artist can choose to log into the web site (act 2004). If the artist doesn't already have a login, or the artist's user name and/or password doesn't already exist in the music distribution system database (act 2006), the artist is presented with an interface that allows him/her to create a user name with a password and record information such as an email address, age, or a nickname that is displayed to people such as referees (e.g., those who refer others to certain content) and referrals (e.g., those who are referred by a referee) (act 2008). Alternative methods of logging in may be used, such as using cookies and like mechanisms.

The user may be presented with an end user license agreement [EULA] that states the policies, rules, disclaimers, etc. involved with the use of the music distribution system (act 2010). If the user chooses to not accept the EULA, registration halts and no further action is taken; if the user accepts the EULA, a welcome email is sent to the user (act 2012) using the email address specified in step (act 2008) and the user is returned to the band login page (act 2004).

After a user successfully logs in (act 2006), he or she is taken to the page that has been customized for his/her band (act 2014) where items such as display statistics are available for viewing (act 2016). After reviewing the web site, the user is provided with the opportunity to provide information such as feedback about the web site, reviews, or quotes to music distribution system personnel such as a PR representative or editor, to modify or supplement the band-customized web site (act 2020). Afterward, the user can refresh his/her browser to view any changes (act 2022).

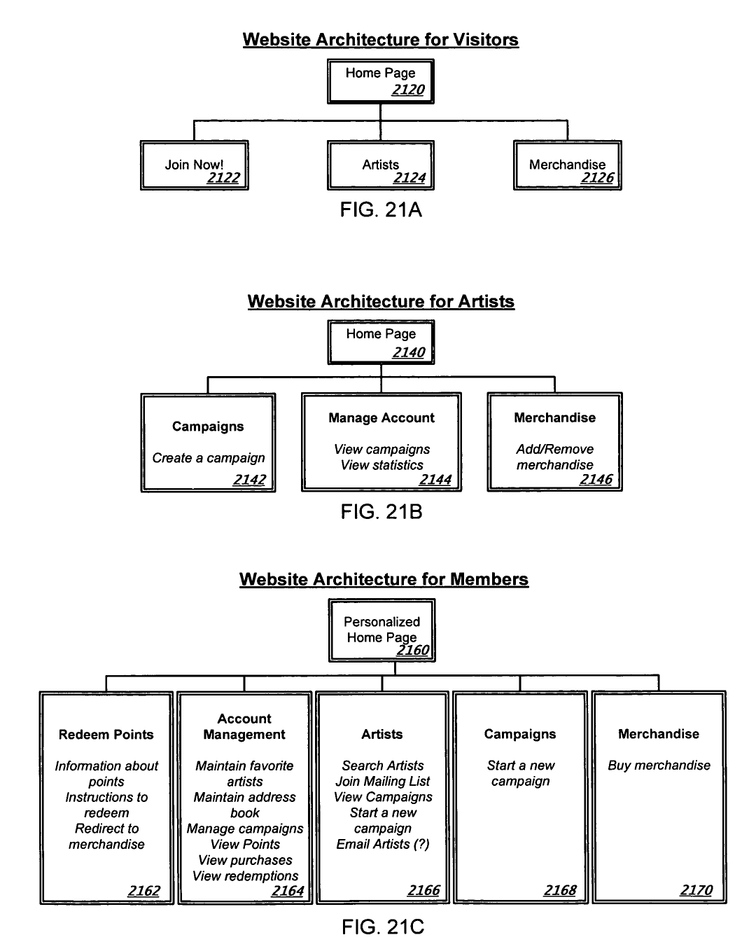

FIGS. 21A-21C show exemplary web site maps for a music distribution system. Depending on whether a non-member/non-artist, an artist, or a registered member is visiting the music distribution system web site, various web site configurations may be presented to a user's browser.

A visitor who is neither an non-artist nor a member may be served with a home page containing general information about the music distribution system (act 2120). The main page may contain links that allow the visitor to, for example, join the music distribution system and become a member (act 2122). Other pages allow the visitor to view information about artists who use the music distribution system (act 2124). Still other pages may incent the visitor to become a member, for example, by showing merchandise that is available for purchase or that may be awarded using the music distribution system (act 2126).

An artist who views the music distribution system may be directed to a web site customized for use by artists (act 2140). The artists may be directed to the alternate website using common methods such as a separate URL, a cookie placed on the artist's computer that identifies the user as an artist, a login from the standard website, or other means known to those skilled in the art. The customized website may be customized for an individual artist, a single website used for all artists, or some combination thereof. The customized website may, for example, have links to pages that the artist may use to create campaigns (act 2142), manage accounts (act 2144), or manage merchandise for sale and available as awards (act 2146).

A member viewing the music distribution system website may be presented with a personalized home page (act 2160) with links to, for example, pages with information on redeeming points (act 2162), account management (act 2164), artists (act 2166), campaigns (act 2168), or merchandise (act 2170).

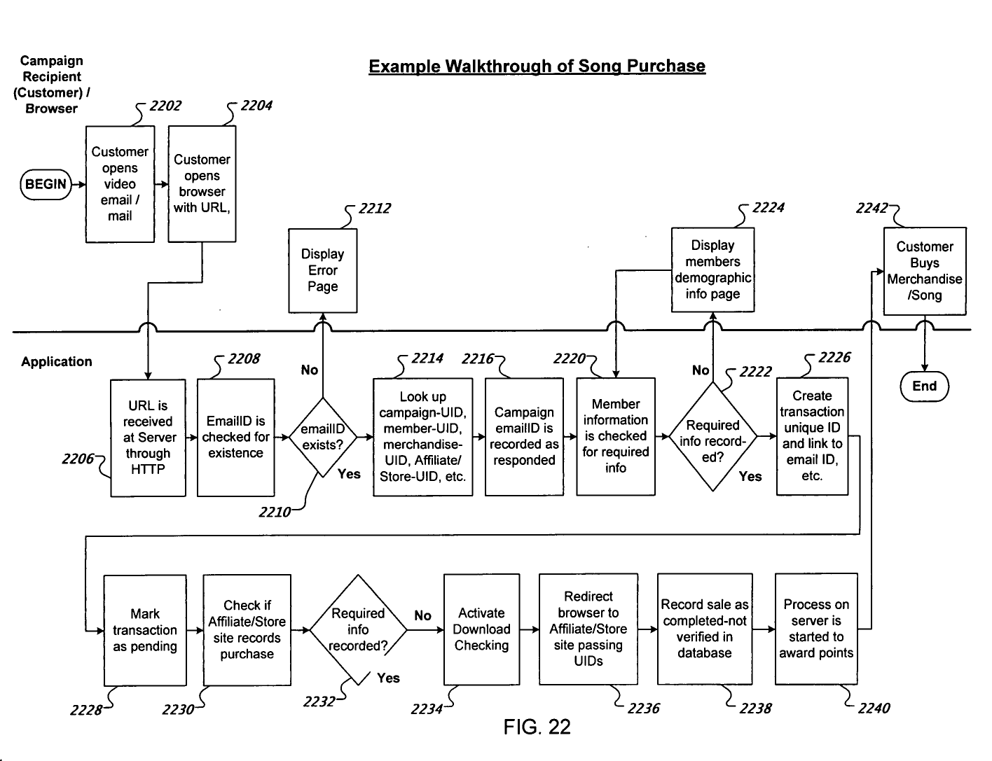

FIG. 22 shows a flowchart of a process for purchasing a song using a music distribution system. In this example, a customer uses a URL to access a campaign web page that records member information and awards points to the member that are used for buying merchandise and/or songs.

A customer initially opens a video email or email containing a URL link to a campaign (act 2202). The customer then directs his/her browser to the location specified, such as by selecting the included URL (act 2204). The music distribution system server receives the URL via an HTTP communication (act 2206) and checks whether the embedded emailID exists 2206. If the email ID does not exist (act 2210), an error page may be sent to the customer's browser with an appropriate error message and a mechanism that allows the customer to search for a campaign, as in FIG. 6.

In this example, the emailID does exist, so the music distribution system application looks up the campaign-UID, member-UID, merchandise UID, affiliate store-UID, etc. (act 2214). The campaign emailID is then recorded as “responded” 2216 and the member information is checked for the required information (act 2220).

Initially, some of the required information is not recorded 2222, so a page is sent to the member's browser indicating that more demographic information is required (act 2224). The application checks the member information again (act 2220) after the member submits the required information. This time, the required demographic information has been recorded, so the application creates a transaction unique ID, a link to email ID, and other appropriate structures (act 2226), before marking the transaction as pending 2228. The music distribution system application then checks whether the affiliate/store recorded the purchase 2230.

In this example, the required information was not recorded, so download checking is activated 2234. Download checking may be a related application that tracks browser interactions so that a site and any information entered on that site (e.g., user interactions to determine what transactions were recorded at the affiliate) may be captured. Following activation, the application redirects the member's browser to an affiliate/store web site, and passes UIDs (act 2236), such as by HTTP parameters that may vary by vendor, and may include an ID for the merchandise, an ID for the administrator, and an ID for the e-mail. The application then records the sale as completed, but not verified in a database (act 2238), and starts a process on the music distribution system server to award points (act 2240). The customer then acquires merchandise, such as songs, with the points they have been awarded 2242.

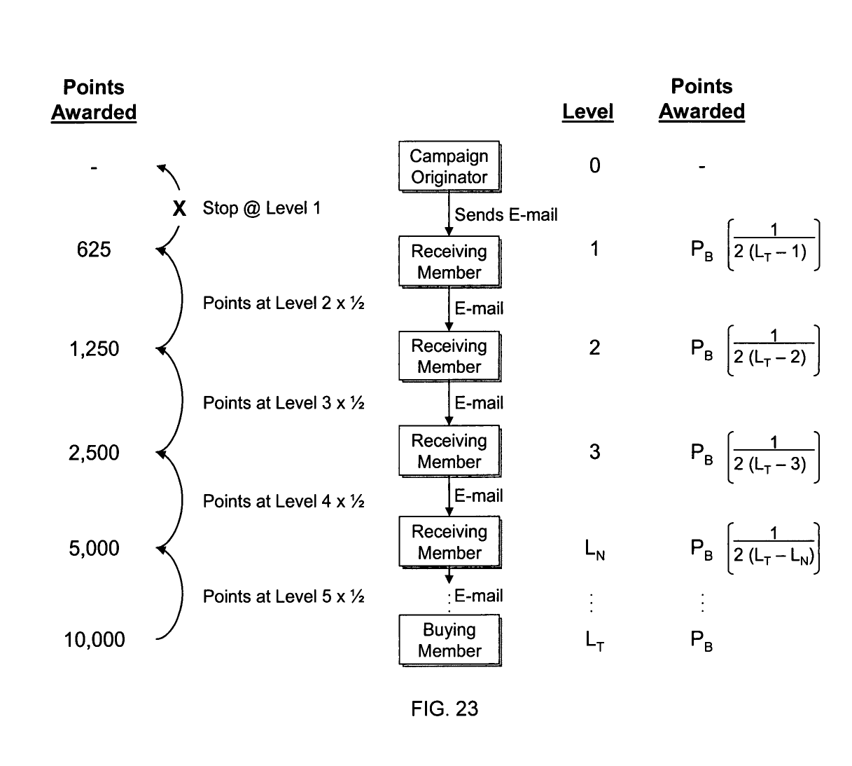

FIG. 23 shows graphically a mechanism for allocating points. The figure generally shows a number of users of an awards system, working upward from a user who has purchased an item to the original user who started a referral process. In this example, the referral process has occurred through successive e-mail notifications, though it could occur through other notification mechanisms such as text messaging or messages that direct users to particular web pages. The system has determined the relationships by tracking the flow of e-mails between the members.

In the exemplary e-mail referral embodiment, a campaign originator, which may be a vendor as discussed above, may initiate a campaign such as by sending e-mails to a number of individuals or by having a central system do so (e.g., by providing the system with e-mail contact information). The system may form a relationship between the originating user and the receiving user, for later point allocation purposes. The e-mails may contain a tracking device such as a specially encoded hyperlink that identifies the campaign.

The recipient may select a hyperlink to be taken to a web page for the campaign and may then enroll with the system, or if they are already enrolled, they may purchase items or may make referrals to other individuals. They may make a referral, for example, by providing the system with e-mail contact information for other users so that the system sends e-mail notifications to those user. The system may then form a relationship between the users, and by extension, a relationship may be formed or inferred between the originating member and the second user. This process may be repeated as appropriate to deeper levels of relationship. In the pictured example, the relationships run to five levels.

As shown, the user at the fifth level has made a purchase entitling that user to an award of 10,000 points. In the exemplary embodiment, points are then awarded to other users having a relationship with the buying member at a rate of one-half the original award for each level of relationship removed from the buying member. In the figure, P_{B} represents the points for buying an item, and the formula for calculating points is:

P_{B}*(1/(2*(L_{T}−L_{N}))

where L is the level of relationship, and L_{T} is the total levels

In theory, the number of points could get exceedingly (essentially infinitely) large as the number of referrals gets exceedingly large. As a practical matter, however, referral levels should stay at a relatively small number. Nonetheless, mechanisms may be provided to ensure that a particular purchase does not result in an excessively high point award simply because many users are related, directly or indirectly, to the buying member. For example, a maximum number of points may be awarded, with users falling far away from the buying member not getting any points if the points have already run out. Also, the finite number of points may be awarded on a percentage basis across the relationships, with the percentage calculated for each member first, rather than the points for each member.

Although the relationships here are campaign-specific, more general relationships may also be formed, as discussed above. Depending on the form of the system and the campaign, points may be distributed only for specific relationships, or for more general relationships, or both. The mechanisms and parameters for distributing points may be the same or different for different forms of relationships. For example, higher point values may be awarded for specific relationships, and lower for more general relationships, so as to highly incent current referral activity, but to still provide some incentive to originally bring new users into the system. Also, award levels may decay at different rates for each level of relationship depending on the form of relationship.

In areas other than electronic media distribution (e.g., music, television, and movies), the systems and techniques described here may also provide benefits in tracking relationships between and among users of a system, and incenting users to encourage positive actions by other users. For example, charities may use such systems to encourage donating parties to recruit and encourage other parties to donate. Also, consumer products companies may use relationships between and among their customers and potential customers to spread the word about new products, and to improve the distribution of such products to users who might find the products most helpful. Providers of services (e.g., telephone or television service, etc.) may use such systems in a similar manner. For example, users of service may receive free or discounted services for referring others to a system or for increasing the usage of a system by others.

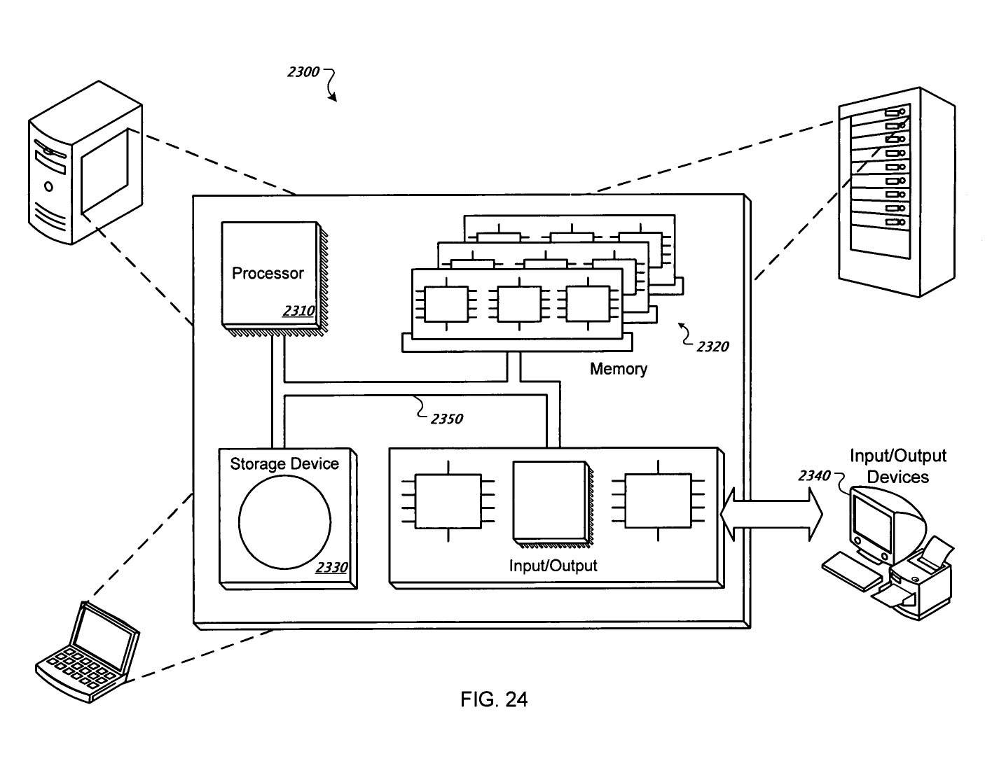

FIG. 24 is a schematic diagram showing components in a computer system suitable to be used with the systems and methods described in this document. The system 2300 can be used for the operations described in association with the methods discussed above.

The system 2300 includes a processor 2310, a memory 2320, a storage device 2330, and an input/output device 2340. Each of the components 2310, 2320, 2330, and 2340 are interconnected using a system bus 2350. The processor 2310 is capable of processing instructions for execution within the system 2300. In one implementation, the processor 2310 is a single-threaded processor. In another implementation, the processor 2310 is a multi-threaded processor. The processor 2310 is capable of processing instructions stored in the memory 2320 or on the storage device 2330 to display graphical information for a user interface on the input/output device 2340.

The memory 2320 stores information within the system 2300. In one implementation, the memory 2320 is a computer-readable medium. In one implementation, the memory 2320 is a volatile memory unit. In another implementation, the memory 2320 is a non-volatile memory unit.

The storage device 2330 is capable of providing mass storage for the system 2300. In one implementation, the storage device 2330 is a computer-readable medium. In various different implementations, the storage device 2330 may be a floppy disk device, a hard disk device, an optical disk device, or a tape device.

The input/output device 2340 provides input/output operations for the system 2300. In one implementation, the input/output device 2340 includes a keyboard and/or pointing device. In another implementation, the input/output device 2340 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, while much of the discussion has centered on sale and distribution of electronic media, and in particular music, other very different items may be traded, and points awarded, with the systems and methods discussed here. For example, charitable giving may be managed by administrators as discussed above. Also, physical items may be sold or provided for free; for example, companies hoping to have consumers try new products may sign up as vendors, and potentially as affiliates for the products. Users may also be awarded points in various forms for encouraging others with whom they have relationships to test the products, and may receive points for it. Likewise, products such as video games may be sold and distributed in both physical and electronic form using the systems and methods described. Accordingly, other embodiments are within the scope of the following claims.

What is claimed is:

1. A computer-implemented method for improving the distribution of electronic media, comprising:
forming relationships among users of a media administration system;
initiating a time-limited campaign for promoting the distribution of one or more related media items;
obtaining information regarding on-line media purchases of the one or more related media items by the users of the media distribution system; and
allocating points for the media purchases across related users based on the relationships among the users.

2. The method of claim 1, wherein the information regarding on-line media purchases is obtained from one or more organizations that are independent of the media administration system.

3. The method of claim 1, wherein the points are allocated across multiple distances of relationship, with fewer points awarded for more distant relationships.

4. The method of claim 1, wherein the relationships among the users include referral relationships formed for a single media item.

5. The method of claim 1, wherein the campaign is time-limited according to a time to award a predetermined number of points.

6. The method of claim 1, further comprising directing the award to be delivered to users of items of value related to the media items.

7. The method of claim 6, wherein the direction is given to an entity associated with an artist that created the one or more media items.

8. The method of claim 1, wherein the media items comprise individual songs.

9. The method of claim 1, wherein the allocated points are a predetermined number of points that are allocated by computing shares of the total points to be allocated to each of one or more members.

10. The method of claim 1, wherein the points are in the form of a numeric amount convertible to items of value.

11. A system for managing electronic media distribution, comprising:
a member database storing identifiers for members of the system and relationships between members;
an interface in communication with one or more media sellers to receive information about media sales by the one or more media sellers along with information identifying one or more members of the system the purchase media; and
a point allocation engine adapted to assign points to members in the member database according to relations between the members.

12. The system of claim 11, wherein the point allocation engine assigns points according to a method selected by a content vendor.

13. The system of claim 11, further comprising a campaign manager module that controls the award of points to members during a defined campaign time period.

14. The system of claim 11, wherein the point allocation engine assigns points across multiple distances of relationship, with fewer points awarded for more distant relationships.

15. The system of claim 14, wherein the relationships among the users include referral relationships formed for a single media item.

16. The system of claim 11, further comprising an interface in communication with award fulfillment entities that directs the award fulfillment entities to deliver merchandise to members in exchange for accrued member points.

17. The system of claim 1, further comprising a media library and a fulfillment module for delivering media in the library to members in exchange for accrued member points.

18. A computer-implemented method, comprising:
identifying relationships between a plurality of users of a networked computer award distribution system;
defining one or more point allocation structures for controlling points to be awarded to first users as a result of purchase transactions by second users based on relationships between the first and second users;
obtaining information regarding purchases of one or more items by the second users; and
allocating points for the purchases across related users based on the relationships among the users.

19. The method of claim 1, wherein the information regarding purchases is obtained from one or more organizations that are independent of the media administration system.

20. The method of claim 1, wherein the points are allocated across multiple distances of relationship, with fewer points awarded for more distant relationships.

21. The method of claim 1, further comprising obtaining the information regarding purchases during a campaign that is time-limited according to a time to award a predetermined number of points.

22. A system for managing electronic media distribution, comprising:
a member database storing identifiers for members of the system and relationships between members;
an interface in communication with one or more media sellers to receive information about media sales by the one or more media sellers along with information identifying one or more members of the system that purchase media; and
means for allocating points across members of the system in relation to transactions by members with the one or more media sellers.
